(19) United States
(12) Patent Application Publication
(10) Pub. No.: US 2025/0276239 A1
(43) Pub. Date: Sep. 4, 2025

(54) DATA PROCESSING

(71) Applicant: TENCENT TECHNOLOGY (SHENZHEN) COMPANY LIMITED, Shenzhen (CN)

(72) Inventors: Yajun ZHANG, Shenzhen (CN); Xi TANG, Shenzhen (CN); Boyuan PAN, Shenzhen (CN)

(73) Assignee: TENCENT TECHNOLOGY (SHENZHEN) COMPANY LIMITED, Shenzhen (CN)

(21) Appl. No.: 19/212,132

(22) Filed: May 19, 2025

Related U.S. Application Data
(63) Continuation of application No. PCT/CN2024/074029, filed on Jan. 25, 2024.

(30) Foreign Application Priority Data
Jan. 28, 2023 (CN) 202310042499.1

(51) Int. Cl. A63F 13/285; G06F 3/01; G06F 3/02; G06F 3/0338; G06F 3/0346; G06F 3/0354; G06F 3/038

(52) U.S. Cl. CPC A63F 13/285; G06F 3/016; G06F 3/0346; G06F 3/038; G06F 3/02; G06F 3/0338; G06F 3/03547

(57) ABSTRACT

In some aspects, first service data information associated with a peripheral device is obtained by the peripheral device configured to support a first communication protocol. The first service data information includes input data structure information that represents an input service feature of the peripheral device, and the input data structure information includes at least one or more of object operation data information, device attribute data information, and device battery strength data information. The first service data information is uploaded to a cloud application client running on a terminal device by using a first input interface of the peripheral device configured according to the first communication protocol. Apparatus and non-transitory computer-readable storage medium counterpart embodiments are also contemplated.

### RELATED APPLICATIONS

The present application is a continuation of International Application No. PCT/CN2024/074029, filed on Jan. 25, 2024, which claims priority to Chinese Patent Application No. 202310042499.1, filed on Jan. 28, 2023. The entire disclosures of the prior applications are hereby incorporated by reference.

### FIELD OF THE TECHNOLOGY

This application relates to the field of data processing technologies.

### BACKGROUND OF THE DISCLOSURE

A working principle of a cloud application (for example, a cloud game) is to change a usage manner of local software installation and computing into a ready-to-use service, that is, a new application in which service logic or a computing task is completed by connecting and controlling a remote server cluster through the Internet or a local area network. A service object may obtain operation data of the service object by using a peripheral device (for example, a mouse, a keyboard, or a gamepad). Then, the peripheral device sends the operation data of the object to a terminal device on which a cloud application client runs. The cloud application client then sends the received operation data to a cloud server, so that the cloud server renders an application display image based on the operation data, thereby controlling image display of a cloud game. The inventor finds during practice that currently, when a peripheral device transmits data to a cloud application client, the data needs to be forwarded by a management component of an operating system of a terminal device, and the management component can only forward an input/output signal corresponding to a supported communication protocol. Therefore, this manner is limited by the communication protocol in the operating system. Therefore, once the peripheral device extends a new skill, when the operating system of the terminal device exchanges data with the peripheral device, limited by the original communication protocol of the operating system, it is difficult to forward an input signal sent by the peripheral device supporting the new skill. As a result, the cloud application client running on the terminal device cannot obtain the input signal sent by the peripheral device supporting the new skill. Therefore, the original communication protocol of the operating system limits transmission efficiency of indirect data transmission between the peripheral device and the cloud application client.

### SUMMARY

Embodiments of this disclosure provide a data processing method and apparatus and a related device, which can reduce and/or eliminate communication limitation during data transmission between a peripheral device and a cloud application client by using a first communication protocol, thereby improving skill utilization of the peripheral device and improving transmission efficiency of direct data transmission between the peripheral device and the cloud application client.

Some aspects of the disclosure provide a method of data processing. In some examples, first service data information associated with a peripheral device is obtained by the peripheral device configured to support a first communication protocol. The first service data information includes input data structure information that represents an input service feature of the peripheral device, and the input data structure information includes at least one or more of object operation data information, device attribute data information, and device battery strength data information. The first service data information is uploaded to a cloud application client running on a terminal device by using a first input interface of the peripheral device configured according to the first communication protocol. The cloud application client transmits the first service data information to a virtual cloud client running in a cloud server, the virtual cloud client is configured to support the first communication protocol and to cause the cloud server to parse the first service data information according to the first communication protocol to obtain input data information of the input service feature according to the input data structure information and to obtain media data information to be returned to the cloud application client as a response to the input data information, and the cloud application client is configured to output the media data information as the response to the input data information.

Some aspects of the disclosure provide a method of data processing. For example, at a peripheral device and by using a first output interface of the peripheral device configured to support a first communication protocol, a first feedback instruction is received from a cloud application client running on a terminal device. Feedback data structure information is identified based on the first communication protocol and according to the first feedback instruction. The feedback data structure information represents a feedback service feature of the peripheral device. Usage of the feedback data structure information in first service data information associated with the peripheral device is determined. A feedback operation is performed based on the feedback data structure information in the first service data information. The feedback data structure information includes at least one of device heartbeat feedback information and device vibration feedback information of the peripheral device.

Some aspects of the disclosure provide a method of data processing. For example, first service data information associated with a peripheral device is received by a terminal device running a cloud application client and supporting a first communication protocol. The first service data information includes input data structure information representing an input service feature of the peripheral device, and the input data structure information includes at least one of object operation data information, device attribute data information, and device battery strength data information. The first service data information is transmitted to a virtual cloud client for the cloud application client. The virtual cloud client runs in a cloud server. The first service data information causes the cloud server to parse the first service data information to obtain input data information according to the input data structure information, to obtain media data information in a response to the input data information and to return the media data information to the cloud application client. The media data information in the response to the input data information is received at the terminal device. Further, the media data information is output by using the cloud application client.

According to one aspect of the embodiments of this disclosure, a data processing method is provided, executed by a peripheral device that supports a first communication protocol. The method includes:
obtaining first service data information associated with the peripheral device; the first service data information including input data structure information configured for representing an input service feature of the peripheral device, and the input data structure information including at least one or more of object operation data information, device attribute data information, and device battery strength data information; and
uploading the first service data information to a cloud application client by using a first input interface indicated by the first communication protocol, so that the cloud application client transmits the first service data information to a virtual cloud client corresponding to the cloud application client; the virtual cloud client running in a cloud server, the first service data information being configured to instruct the cloud server to identify a data structure type of the first service data information when the virtual cloud client supports the first communication protocol, and when identifying that the data structure type of the first service data information is a first data structure type, instruct the cloud server to parse the first service data information to obtain input data information indicated by the input data structure information, and instruct the cloud server to obtain media data information that corresponds to the input data information and that is to be returned to the cloud application client, and the cloud application client being configured to output the media data information corresponding to the input data information.

According to one aspect of the embodiments of this disclosure, a data processing method is provided, executed by a peripheral device that supports a first communication protocol. The method includes:
receiving a first feedback instruction; the first feedback instruction being delivered by a cloud application client by using a first output interface indicated by the first communication protocol;
identifying, based on the first communication protocol, a data structure type of feedback data structure information indicated by the first feedback instruction; and
when identifying that the data structure type of the feedback data structure information is a first data structure type, using, as first service data information associated with the peripheral device, the feedback data structure information configured for representing a feedback service feature of the peripheral device, and performing a feedback operation indicated by the feedback data structure information in the first service data information; the feedback data structure information including at least one or more of device heartbeat feedback information and device vibration feedback information of the peripheral device.

According to one aspect of the embodiments of this disclosure, a data processing method is provided, executed by a terminal device. A cloud application client running in the terminal device supports a first communication protocol. The method includes:
receiving first service data information associated with a peripheral device; the first service data information being uploaded by a peripheral device by using a first input interface indicated by the first communication protocol, the first service data information including input data structure information configured for representing an input service feature of the peripheral device, and the input data structure information including at least one or more of object operation data information, device attribute data information, and device battery strength data information;
transmitting the first service data information to a virtual cloud client corresponding to the cloud application client; the virtual cloud client running in a cloud server, and the cloud server being configured to identify a data structure type of the first service data information when the virtual cloud client supports the first communication protocol, and when identifying that the data structure type of the first service data information is a first data structure type, parse the first service data information to obtain input data information indicated by the input data structure information, and obtain media data information that corresponds to the input data information and that is to be returned to the cloud application client, and
receiving the media data information that corresponds to the input data information and that is returned by the cloud server, and outputting the media data information by using the cloud application client.

According to one aspect of the embodiments of this disclosure, a data processing method is provided, executed by a terminal device. A cloud application client running in the terminal device supports a first communication protocol. The method includes:
obtaining, by using the cloud application client, a first feedback instruction to be delivered to a peripheral device; and
delivering the first feedback instruction to the peripheral device based on a first output interface indicated by the first communication protocol, so that the peripheral device identifies, based on the first communication protocol, a data structure type of feedback data structure information indicated by the first feedback instruction, and when identifying that the data structure type of the feedback data structure information is a first data structure type, uses, as first service data information associated with the peripheral device, the feedback data structure information configured for representing a feedback service feature of the peripheral device, and performs a feedback operation indicated by the feedback data structure information in the first service data information; the feedback data structure information including at least one or more of device heartbeat feedback information and device vibration feedback information of the peripheral device.

According to one aspect of the embodiments of this disclosure, a data processing apparatus is provided, run by a peripheral device that supports a first communication protocol. The apparatus includes:
a service data obtaining module, configured to obtain first service data information associated with the peripheral device; the first service data information including input data structure information configured for representing an input service feature of the peripheral device, and the input data structure information including at least one or more of object operation data information, device attribute data information, and device battery strength data information; and
a data uploading module, configured to upload the first service data information to a cloud application client by using a first input interface indicated by the first communication protocol, so that the cloud application client transmits the first service data information to a virtual cloud client corresponding to the cloud application client; the virtual cloud client running in a cloud server, the first service data information being configured to instruct the cloud server to identify a data structure type of the first service data information when the virtual cloud client supports the first communication protocol, and when identifying that the data structure type of the first service data information is a first data structure type, instruct the cloud server to parse the first service data information to obtain input data information indicated by the input data structure information, and instruct the cloud server to obtain media data information that corresponds to the input data information and that is to be returned to the cloud application client, and the cloud application client being configured to output the media data information corresponding to the input data information.

According to one aspect of the embodiments of this disclosure, a data processing apparatus is provided, run by a peripheral device that supports a first communication protocol. The apparatus includes:
a data receiving module, configured to receive a first feedback instruction; the first feedback instruction being delivered by a cloud application client by using a first output interface indicated by the first communication protocol;
a data structure parsing module, configured to identify, based on the first communication protocol, a data structure type of feedback data structure information indicated by the first feedback instruction; and
a feedback operation execution module, configured to: when it is identified that the data structure type of the feedback data structure information is a first data structure type, use, as first service data information associated with the peripheral device, the feedback data structure information configured for representing a feedback service feature of the peripheral device, and perform a feedback operation indicated by the feedback data structure information in the first service data information; the feedback data structure information including at least one or more of device heartbeat feedback information and device vibration feedback information of the peripheral device.

According to one aspect of the embodiments of this disclosure, a data processing apparatus is provided, executed by a terminal device. A cloud application client running in the terminal device supports a first communication protocol. The apparatus includes:
a first data receiving module, configured to receive first service data information associated with a peripheral device; the first service data information being uploaded by the peripheral device by using a first input interface indicated by the first communication protocol, the first service data information including input data structure information configured for representing an input service feature of the peripheral device, and the input data structure information including at least one or more of object operation data information, device attribute data information, and device battery strength data information;
a data uploading module, configured to transmit the first service data information to a virtual cloud client corresponding to the cloud application client; the virtual cloud client running in a cloud server, and the cloud server being configured to identify a data structure type of the first service data information when the virtual cloud client supports the first communication protocol, and when identifying that the data structure type of the first service data information is a first data structure type, parse the first service data information to obtain input data information indicated by the input data structure information, and obtain media data information that corresponds to the input data information and that is to be returned to the cloud application client, and
a second data receiving module, configured to receive the media data information that corresponds to the input data information and that is returned by the cloud server, and output the media data information by using the cloud application client.

According to one aspect of the embodiments of this disclosure, a data processing apparatus is provided, executed by a terminal device. A cloud application client running in the terminal device supports a first communication protocol. The apparatus includes:
a data deliver module, configured to obtain, by using the cloud application client, a first feedback instruction to be delivered to a peripheral device;
the data deliver module being configured to deliver the first feedback instruction to the peripheral device based on a first output interface indicated by the first communication protocol, so that the peripheral device identifies, based on the first communication protocol, a data structure type of feedback data structure information indicated by the first feedback instruction, and when identifying that the data structure type of the feedback data structure information is a first data structure type, uses, as first service data information associated with the peripheral device, the feedback data structure information configured for representing a feedback service feature of the peripheral device, and performs a feedback operation indicated by the feedback data structure information in the first service data information; the feedback data structure information including at least one or more of device heartbeat feedback information and device vibration feedback information of the peripheral device.

According to one aspect of the embodiments of this disclosure, a computer-readable storage medium (e.g., non-transitory computer-readable storage medium) is provided, having a computer program stored therein, the computer program being configured to be loaded and executed by a processor, to cause a computer device having the processor to perform the data processing method provided in the embodiments of this disclosure.

According to one aspect of the embodiments of this disclosure, a computer program product is provided, including a computer program, the computer program being stored in a computer-readable storage medium. A processor of a computer device reads and executes the computer program from the computer-readable storage medium, to cause the computer device to perform the data processing method provided in the embodiments of this disclosure.

The embodiments of this disclosure provide a data processing method for resolving a problem of limitation of data transmission between the peripheral device and the terminal device. In the data processing method, without changing an original hardware structure of the peripheral device, data may be transmitted between the peripheral device and the cloud application client on the terminal device by using the first input interface or the first output interface indicated by the first communication protocol. In the embodiments of this disclosure, data transmitted based on the first communication protocol between the peripheral device and the terminal device on which the cloud application client runs may be collectively referred to as the first service data information. In other words, in the embodiments of this disclosure, if both the peripheral device and the cloud application client support the first communication protocol, when the peripheral device transmits data (that is, the first service data information) with the cloud application client of the terminal device based on the first communication protocol, the data does not need to be forwarded by a management component of an operating system, and instead, the data (that is, the first service data information, for example, the input data structure information configured for representing the input service feature of the peripheral device, where the input data structure information herein includes at least one or more of the object operation data information, the device attribute data information, and the device battery strength data information) is directly sent to the cloud application client of the terminal device based on the first communication protocol. In this way, the peripheral device may send more diversified data (for example, the object operation data information, the device attribute data information, and the device battery strength data information of the peripheral device) to the cloud application client for final transfer to the cloud server, thereby implementing more diversified capabilities of controlling a cloud application (for example, a cloud game). Similarly, the cloud application client may also send more diversified data (for example, the feedback data structure information configured for representing the feedback service feature of the peripheral device, where the feedback data structure information herein at least includes one or more of device heartbeat feedback information and device vibration feedback information of the peripheral device) to the peripheral device, to enrich playing methods of the cloud game and bring better immersive experience to a service object. Therefore, the embodiments of this disclosure can eliminate communication limitation during data transmission between the peripheral device and the cloud application client based on the first communication protocol, thereby improving skill utilization of the peripheral device and improving transmission efficiency of direct data transmission between the peripheral device and the cloud application client.

### BRIEF DESCRIPTION OF THE DRAWINGS

FIG. 1 is a schematic structural diagram of a data processing system according to an embodiment of this disclosure;

FIG. 2 is a schematic diagram of an effect of a second service mode according to an embodiment of this disclosure;

FIG. 3 is a schematic diagram of an effect of a first service mode according to an embodiment of this disclosure;

FIG. 4 is a schematic structural diagram of a communication module of a peripheral device according to an embodiment of this disclosure;

FIG. 5 is a schematic flowchart 1 of a data processing method according to an embodiment of this disclosure;

FIG. 6 is a schematic flowchart of querying a service feature supported by a peripheral device according to an embodiment of this disclosure;

FIG. 7 is a schematic diagram of an effect of displaying media data information according to an embodiment of this disclosure;

FIG. 8 is a schematic flowchart of uploading object operation data information according to an embodiment of this disclosure;

FIG. 9 is a schematic diagram of an effect of displaying another type of media data information according to an embodiment of this disclosure;

FIG. 10 is a schematic diagram of an effect of displaying still another type of media data information according to an embodiment of this disclosure;

FIG. 11 is a schematic flowchart 2 of a data processing method according to an embodiment of this disclosure;

FIG. 12 is a schematic flowchart of transmitting heartbeat feedback information according to an embodiment of this disclosure;

FIG. 13 is a schematic flowchart of transmitting vibration feedback information according to an embodiment of this disclosure;

FIG. 14 is a schematic flowchart 3 of a data processing method according to an embodiment of this disclosure;

FIG. 15 is a schematic flowchart of a data exchange process according to an embodiment of this disclosure;

FIG. 16 is a schematic flowchart 4 of a data processing method according to an embodiment of this disclosure;

FIG. 17 is a schematic flowchart 5 of a data processing method according to an embodiment of this disclosure;

FIG. 18 is a schematic flowchart 6 of a data processing method according to an embodiment of this disclosure;

FIG. 19 is a schematic structural diagram of a data processing apparatus 1 according to an embodiment of this disclosure;

FIG. 20 is a schematic structural diagram of a data processing apparatus 2 according to an embodiment of this disclosure;

FIG. 21 is a schematic structural diagram of a data processing apparatus 3 according to an embodiment of this disclosure;

FIG. 22 is a schematic structural diagram of a data processing apparatus 4 according to an embodiment of this disclosure; and

FIG. 23 is a schematic structural diagram of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Input device: An input device herein is a hardware device, such as a mouse, a keyboard, a gamepad, or a game steering wheel that can be directly operated by a service object (for example, a user) to send a corresponding control instruction. For ease of understanding, in the embodiments of this disclosure, input devices herein may be collectively referred to as peripheral devices.

Terminal device: A terminal device herein is a hardware device, such as a television, a mobile phone, or a personal computer that can receive input data information of an input device and feed back information such as sound and images to a service object (for example, a user). In the embodiments of this disclosure, the terminal device herein may directly perform data transmission with a peripheral device based on a first communication protocol.

A cloud application, as a subset of cloud computing, is representation of a cloud computing technology at an application layer. A working principle of a cloud application is to change a usage manner of local software installation and computing into a ready-to-use service, that is, a new application in which service logic or a computing task is completed by connecting and controlling a remote server cluster through the Internet or a local area network. Advantages of the cloud application are as follows: A corresponding virtual cloud client runs on a cloud server, so that the cloud server performs computing work (such as data rendering) of a cloud application, and then transmits a computing result of the cloud application to a cloud application client on a terminal device for displaying. The cloud application client on the terminal device may collect input operation information (or may be referred to as input event data of the cloud application) of a service object, and transmit the input operation information to the virtual cloud client on the cloud server, to implement control of the cloud application by the cloud server. The cloud application client on the terminal device can provide a corresponding cloud application experience service for a service object. To put it simply, the cloud application client may be configured to output a cloud application presentation page corresponding to a virtual cloud client. The cloud application herein may include a cloud game, cloud education, cloud security, a cloud conference, a cloud call, cloud socializing, and the like.

A cloud game can also be referred to as gaming on demand, and is a game technology based on a cloud computing technology. In a cloud game scenario, a game application program is not run on a terminal device used by a service object. Only a cloud application client (also referred to as a cloud game client) runs on the terminal device herein, that is, a real game application program is run in a cloud server. For example, when a cloud game is run, logical processing and image rendering of the cloud game are all performed on a cloud server. This means that when a virtual cloud client corresponding to the cloud game client runs on the cloud server, the cloud game may be loaded and run (that is, a game application program of the cloud game is loaded and run) by using the virtual cloud client, to perform logical processing and image rendering. Then, when obtaining a game image of the cloud game through rendering, the cloud server on which the virtual cloud client runs may transmit a video stream and an audio stream corresponding to the game image to a cloud application client on a terminal device through a network. In this way, a service object can play a game only through a terminal device having a streaming media playback function and a peripheral device that can obtain a control operation. A terminal device of a cloud game does not need to have strong graphic computing and data processing capabilities, and only needs to have a basic streaming media playback capability and a capability of obtaining input event data of a service object and sending the input event data to a virtual cloud client of a cloud server. When experiencing a cloud game, a service object may generate input event data by using a touchscreen, a keyboard, a mouse, a joystick, a gamepad, or the like, and then transmit the input event data to a virtual cloud client on a cloud server by using a network, to operate the cloud game.

A peripheral device is a device other than the host in a computer system, and is configured to provide communication between a computer and another machine or between a computer and a service object. The peripheral device may include a human interface device (HID device). The HID device is a device-type definition, and may be used to replace a PS/2 (an input apparatus interface) style connector with a universal serial bus (USB) drive program supporting the HID device, such as a keyboard, a mouse, or a game controller (for example, a gamepad).

A communication protocol is a rule and an agreement that two entities need to follow to complete communication or a service, and may be simply understood as a common language used by computers to perform mutual sessions. The protocol defines a used format of a data unit, information and meaning that are included in an information unit, a connection manner, and a time sequence of sending and receiving information, so as to ensure that data in a network is successfully transmitted to a specified destination. The communication protocol herein may include at least a first communication protocol. In this embodiment of this disclosure, two entities participating in communication may include a peripheral device and a cloud application client on a terminal device. In this case, the peripheral device and the cloud application client on the terminal device may communicate based on the first communication protocol, to transfer more diversified data (for example, input data structure information configured for representing an input service feature of the peripheral device) on the peripheral device to the cloud application client, so that the cloud application client transfers the data to a cloud server on which a virtual cloud client runs. The first communication protocol is a customized communication protocol that is followed when the peripheral device has more diversified input/output capabilities and data transmission is performed between the peripheral device and the cloud application client on the terminal device. By analogy, the cloud application client on the terminal device and the virtual cloud client on the cloud server may also communicate based on the first communication protocol.

In some aspects, in this embodiment of this disclosure, the communication protocol herein may also include a second communication protocol, that is, the peripheral device and the cloud application client on the terminal device may also communicate based on the second communication protocol. For example, when the peripheral device sends operation data of a service object to the cloud application client on the terminal device, a management component of an operating system of the terminal device may forward the operation data based on the second communication protocol. The second communication protocol is a communication protocol that is used for data transmission and that is currently supported by the management component of the operating system. For ease of understanding, in this embodiment of this disclosure, data forwarded by the management component of the operating system according to the second communication protocol may be collectively referred to as operation data. For ease of distinguishing, data directly transmitted without being forwarded by the management component of the operating system may be collectively referred to as input operation information.

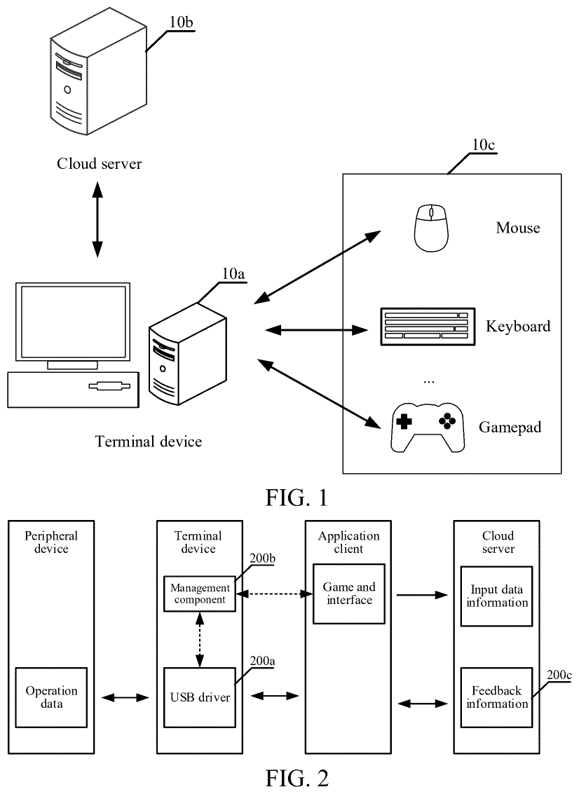

Further, FIG. 1 is a schematic structural diagram of a data processing system according to an embodiment of this disclosure. As shown in FIG. 1, the data processing system may include a terminal device 10a, a cloud server 10b, and a peripheral device 10c. A cloud application client may run on the terminal device 10a. The cloud application client herein may be understood as a client that is installed on the terminal device and can provide a corresponding cloud application experience service for a service object. For example, a cloud application in the cloud application client may include a cloud game (for example, a cloud game 1). The cloud server 10b may be a server on which a virtual cloud application client corresponding to the cloud application client runs. For example, when the cloud game client on the terminal device 10a is configured to provide an experience service of the cloud game 1, a service object may experience the cloud game 1 by using the cloud game client on the terminal device 10a. In this way, when a communication connection is established between the peripheral device 10c and the terminal device 10a, the peripheral device 10c and a service object (also referred to as an object) may exchange data based on the first communication protocol. For example, the peripheral device 10c may directly receive an operation of a service object, to indirectly control display content of a game image (that is, an image) on the terminal device 10a by using a control instruction corresponding to the operation. The peripheral device may be an HID device such as a mouse, a keyboard, or a game controller (for example, a gamepad). This is not limited herein.

When a service object A wants to experience the cloud game 1, the peripheral device 10c may be configured to select the cloud game 1 in the cloud application client (for example, a cloud game client) running on the terminal device 10a, and perform an operation (for example, a startup operation) on the cloud game 1 in the cloud application client. In this case, the peripheral device 10c may generate a startup instruction in response to the startup operation, and then send the startup instruction to the cloud server 10b through the terminal device 10a, to create or allocate a game instance of the cloud game 1 for the service object A in the cloud server 10b (that is, create or allocate a virtual cloud client corresponding to the cloud game 1 for the service object A), and the virtual cloud client corresponding to the cloud game 1 runs on the cloud server 10b. At the same time, the cloud application client on the terminal device 10a is also successfully started, that is, the cloud application client on the terminal device 10a and the virtual cloud client on the cloud server 10b remain in the same running status.

As shown in FIG. 1, when running on the cloud server 10b, the virtual cloud client may execute game logic in the cloud game 1, and use a process to which the virtual cloud client belongs to invoke a rendering interface provided by a graphics processing unit (GPU) driver program, to perform a rendering operation. A rendering result may be sent to the terminal device 10a in a form of media data information. After receiving the media data information sent by the cloud server, the cloud application client on the terminal device 10a may present the media data information. The media data information may include audio and video data information, and displaying the media data information may be displaying, on the terminal device, video images corresponding to the audio data information, and playing corresponding audio.

The service object A may operate the cloud game 1 by operating the peripheral device 10c. For example, the service object A may further control a virtual object in the cloud game 1 to perform a skill operation such as moving, shooting, or stealth by operating the peripheral device 10c. When the service object A performs an operation on the peripheral device 10c, the peripheral device 10c may generate operation data that follows a corresponding communication protocol, and send the operation data to the terminal device in a form of a control instruction, so that the cloud application client may obtain the operation data of the service object A carried in the control instruction, and directly transmit the operation data of the service object A to the virtual cloud client running on the cloud server 10b. The virtual cloud client may continue to perform a rendering operation by using the operation data of the service object A, to generate a new game image. Each game image rendered by the virtual cloud client may be transmitted in real time by the virtual cloud client to the cloud application client on the terminal device 10a for displaying.

A communication connection may be established between the peripheral device 10c and the terminal device 10a by using a USB driver deployed in the terminal device 10a. For example, when the service object A inserts a USB port of the peripheral device 10c into the terminal device 10a or connects the peripheral device to a USB port of the terminal device, the terminal device 10a may scan the peripheral device 10c by using a USB driver, and when obtaining through scanning that the peripheral device 10c supports a USB driver program, the terminal device 10a determines that a communication connection is established between the peripheral device 10c and the terminal device 10a by using the USB driver. The basis on which data can be transmitted between the peripheral device and the terminal device is that a communication connection is established between the peripheral device and the terminal device.

Currently, the peripheral device 10c may perform data transmission with the terminal device 10a based on a second communication protocol. That is, when the peripheral device 10c sends operation data of a service object to the cloud application client on the terminal device 10a, a management component of an operating system of the terminal device 10a may forward the operation data based on the second communication protocol. For example, the peripheral device 10c may generate, based on an operation performed by the service object, operation data that follows the second communication protocol, and then send the operation data to the management component (also referred to as an input management component) of the operating system by using the USB driver of the terminal device 10a, and then the management component forwards the operation data to the cloud application client.

When the terminal device 10a performs data transmission of the operation data based on the management component, a data transmission process of the operation data is limited by a communication protocol (that is, the second communication protocol) supported by the management component. For example, once a new functional service is extended on the peripheral device 10c, for example, an input signal such as six-axis gyroscope sensing and pressure sensing corresponding to operation data that is not supported by the management component of the operating system is supported, when the communication protocol (that is, the second communication protocol) supported by the management component does not support signal transmission of the input signal corresponding to the operation data, the management component cannot correctly forward the input signal corresponding to the operation data to the cloud application client. As a result, the cloud application client cannot be accurately controlled to make a corresponding response by using the operation data.

For ease of understanding, in this embodiment of this disclosure, the communication manner that requires data forwarding by the management component of the operating system of the terminal device may be referred to as a second communication manner, and may also be referred to as an ordinary communication manner. In this way, when the peripheral device needs to transmit the operation data, the peripheral device may transmit data by using the second communication manner (that is, the communication manner indicated by the second communication protocol). That is, in this embodiment of this disclosure, a service mode in which the peripheral device transmits data based on the second communication manner may be referred to as a second service mode. That is, when the peripheral device is in the second service mode, the peripheral device may perform data transmission with the terminal device by using the second communication manner.

For example, FIG. 2 is a schematic diagram of an effect of a second service mode according to an embodiment of this disclosure. As shown in FIG. 2, when the peripheral device (for example, the peripheral device 10c in FIG. 1) is in the second service mode, the peripheral device may generate operation data according to a standard data structure (for example, a data structure belonging to a second data structure type) indicated by the second communication protocol, and then send the operation data to a management component 200b shown in FIG. 2 by using a USB driver 200a in the terminal device (for example, the terminal device 10a in FIG. 1). Then, the management component 200b shown in FIG. 2 forwards the operation data to an application client (for example, the cloud application client) shown in FIG. 2, so that the application client (for example, the cloud application client) shown in FIG. 2 further sends the received operation data in a form of a standard input signal to the cloud server shown in FIG. 2 based on the second communication protocol, so that the cloud server may parse the received standard input signal based on the second communication protocol to obtain the operation data, and further use the operation data obtained through parsing as input data information shown in FIG. 2. As shown in FIG. 2, the cloud server may further generate, based on the input data information, feedback information 200c (for example, information used for feeding back sound and images to the service object) shown in FIG. 2, and then return the feedback information 200c (for example, information used for feeding back sound and images to the service object) to the application client shown in FIG. 2 based on the second communication protocol.

As shown in FIG. 2, when the peripheral device and the terminal device transmit data according to the second communication protocol, the management component 200b of the operating system of the terminal device needs to perform data forwarding. In this way, once a data structure of operation data received by the management component 200b is not a data structure of a second data structure type originally supported by the management component, and instead is a data structure of another data structure type (that is, an extended data structure) that is not currently supported by the management component 200b, it is difficult for the management component 200b to forward operation data generated according to the data structure of the another data structure type (that is, the extended data structure) indicated by another communication protocol. As can be seen, in a service scenario in which the cloud application is a cloud game (for example, the cloud game 1), the application client (for example, the cloud application client) implements game input by using the management component 200b of the operating system, which not only has a problem of limited data transmission between a peripheral device and a terminal device, but also limits playing methods of the cloud game to some extent. Based on this, an embodiment of this disclosure provides a data processing method for resolving the problem of limited data transmission between a peripheral device and a terminal device. The data processing method may provide an extended communication protocol, that is, a first communication protocol, for the second communication protocol, so that data may be transmitted based on a first input interface (also referred to as an extended input interface) or a first output interface (also referred to as an extended output interface) indicated by the first communication protocol. The first communication protocol may conform to the human machine interface (HID) communication protocol of the USB driver, so as to implement transmission of an input signal or an output signal in a specific format. If both the peripheral device and the cloud application client support the first communication protocol, when performing data transmission with the cloud application client on the terminal device based on the first communication protocol, the peripheral device does not require data forwarding by the management component (for example, the management component 200b shown in FIG. 2) of the operating system, and instead directly sends data to the cloud application client on the terminal device by using a USB driver. In this way, the peripheral device may send more diversified data (for example, object operation data information, device attribute data information, and device battery strength data information of the peripheral device) to the cloud application client for final transfer to the cloud server, thereby implementing more diversified capabilities of controlling a cloud application (for example, a cloud game). For ease of understanding, in this embodiment of this disclosure, the communication manner that does not require data forwarding by the management component of the operating system of the terminal device may be referred to as a first communication manner, and may also be referred to as an extended communication manner. In this way, when the peripheral device needs to transmit data, the peripheral device may transmit data by using the first communication manner (that is, the communication manner indicated by the first communication protocol). That is, in this embodiment of this disclosure, a service mode in which the peripheral device transmits data based on the first communication manner may be referred to as a first service mode. That is, when the peripheral device is in the first service mode, the peripheral device may perform data transmission with the terminal device by using the first communication manner, to transmit more diversified data (for example, input operation information, a device attribute, a device battery strength, vibration feedback information, and heartbeat feedback information) compared with the second service mode.

When the peripheral device communicates with the cloud application client based on the first communication protocol, the peripheral device may implement data transmission with various types of terminal devices (such as a mobile phone and a computer) based on the first communication protocol. Therefore, the peripheral device may be modified in software without modifying an original hardware structure of the peripheral device, to use the first communication protocol to fully use a hardware capability that originally cannot be implemented by the peripheral device based on the second communication protocol, so as to provide diversified input manners and game feedbacks, thereby diversifying game experience of the cloud game in the cloud application client. In other words, for an existing peripheral device (for example, a gamepad), the peripheral device does not need to be modified in hardware, and the peripheral device needs to be modified only in software. In this way, when the first communication protocol is written into the peripheral device, it can be ensured that the peripheral device fully uses, based on the first communication protocol, a hardware capability that originally cannot be implemented by the peripheral device. In this way, even on a peripheral device to be produced in the future, the first communication protocol may be correspondingly extended adaptively according to expansion of a hardware capability.

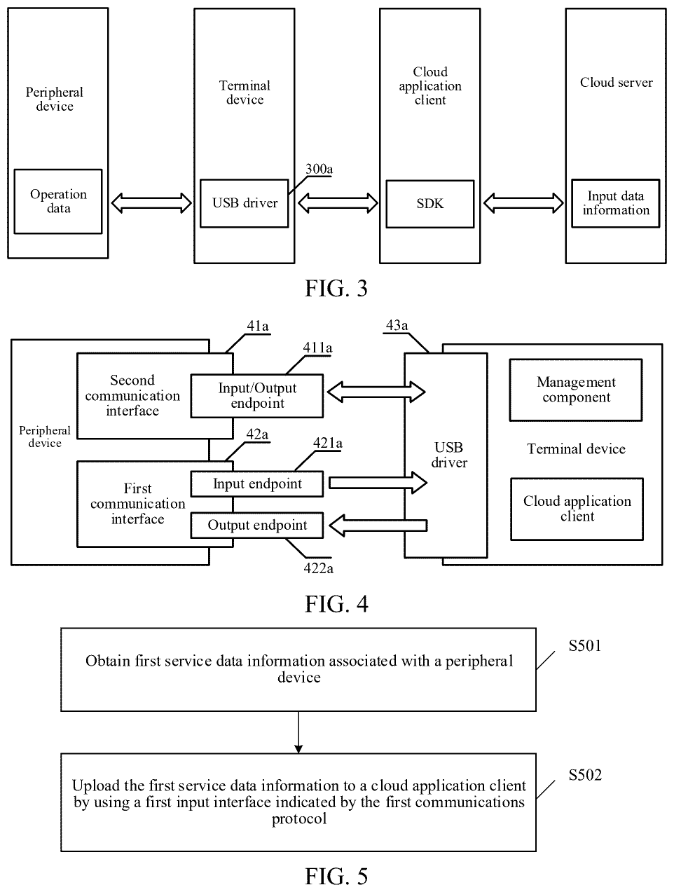

For example, FIG. 3 is a schematic diagram of an effect of a first service mode according to an embodiment of this disclosure. When the peripheral device and the cloud application client support the first communication protocol, the peripheral device (for example, the peripheral device 10c in FIG. 1) may generate, according to a data structure (for example, a data structure belonging to a first data structure type) indicated by the first communication protocol, input data structure information (for example, one or more of object operation data information, device attribute data information, and device battery strength data information) corresponding to input data information, and then may directly send the input data structure information to the cloud application client based on the first communication protocol by using a USB driver 300a in the terminal device, so that the cloud application client may then send the received input data structure information to the cloud server, and then the cloud server may make a corresponding response based on the input data information indicated by the received input data structure information. For example, the cloud server may perform rendering based on the input data information to generate a game image, and deliver the generated game image to the cloud application client in a form of media data information for presentation. In addition, the cloud server shown in FIG. 3 may further generate, according to a data structure indicated by the first communication protocol, feedback data structure information corresponding to feedback information, and return the feedback data structure information to the cloud application client. In this way, the cloud application client may further directly send, based on the first communication protocol, the feedback data structure information to the peripheral device by using the USB driver 300a, so that the peripheral device may perform a corresponding feedback operation based on the feedback information indicated by the feedback data structure information. For example, when the feedback information is device vibration feedback information, the peripheral device may control, based on the device vibration feedback information, a vibration motor in the peripheral device to vibrate.

When the peripheral device is in the second service mode, an interface supported by the peripheral device includes a second interface (also referred to as an ordinary interface), and a data structure type corresponding to the second interface is a second data structure type. In this case, the peripheral device may generate operation data according to a standard data structure indicated by the second communication protocol, that is, when the peripheral device is currently in the second service mode, the data structure type of the operation data generated based on the obtained operation is the second data structure type. As can be seen, when the peripheral device is in the second service mode, the data structure corresponding to the second interface may specifically include a data structure corresponding to the second interface (also referred to as a common interface) used for obtaining object operation data.

In some aspects, when the peripheral device is in the first service mode, an interface supported by the peripheral device includes a first interface (also referred to as an extended interface), and a data structure type corresponding to the first interface is a first data structure type. In this case, data generated according to the data structure (that is, the extended data structure) indicated by the first communication protocol may be collectively referred to as first service data information by the peripheral device. That is, when the peripheral device is currently in the first service mode, a data structure type of another operation data (that is, input operation information such as object operation data) generated based on an obtained operation is the first data structure type. As can be seen, when the peripheral device is in the first service mode, the data structure corresponding to the first interface may specifically include a data structure corresponding to a first interface (also referred to as an extended interface) configured to obtain object operation data (that is, input operation information), a data structure corresponding to a first interface (also referred to as an extended interface) configured to obtain a device attribute, a data structure corresponding to a first interface (also referred to as an extended interface) configured to obtain a device battery strength, and the like.

To make the first communication manner for data transmission based on the first communication protocol be compatible with the second communication manner relying on the operating system of the terminal device, in this embodiment of this disclosure, while the first communication manner based on the first communication protocol is newly added to the peripheral device, the original second communication manner may be reserved. In this way, when the cloud application client does not start a cloud application, data transmission between the peripheral device and the terminal device may still be implemented in the second communication manner. When the cloud application client starts a cloud application, the second communication manner may be switched to the first communication manner, and data transmission with the peripheral device may be implemented in the first communication manner. When starting a cloud application (for example, starting a cloud game), the cloud application client may switch the second communication manner to the first communication manner. In addition, when starting the cloud application, the cloud application client may deliver a mode switching instruction to the peripheral device based on a communication manner (that is, the first communication manner) indicated by the first communication protocol, so that the peripheral device switches a service mode from the second service mode to the first service mode based on the mode switching instruction. Therefore, various service features (for example, an input service feature and a feedback service feature) of the peripheral device may be fully used, thereby improving usage experience of the cloud application.

Based on this, software communication modules of the peripheral device can be implemented according to the following structure. FIG. 4 is a schematic structural diagram of a communication module of a peripheral device according to an embodiment of this disclosure. As shown in FIG. 4, the communication module of the peripheral device may include a second communication interface 41a indicated by a second communication protocol. The second communication interface 41a herein may be a second interface supported by the peripheral device. As shown in FIG. 4, the second communication interface 41a indicated by the second communication protocol may specifically include an input/output endpoint 411a. When the peripheral device is in the second service mode, the peripheral device may send operation data of the peripheral device to a USB driver 43a of the terminal device shown in FIG. 4 by using the input/output endpoint 411a of the second communication interface 41a. Then, the terminal device may obtain the operation data from the USB driver 43a by using the management component, and forward the operation data to a cloud application client shown in FIG. 4. Alternatively, when the peripheral device is in the second service mode, the peripheral device may further receive, by using the input/output endpoint 411a of the second communication interface 41a, feedback information delivered by the terminal device based on the second communication protocol.

As shown in FIG. 4, the communication module of the peripheral device further may include a first communication interface 42a indicated by a first communication protocol. The first communication interface 42a may be a first interface supported by the peripheral device. As shown in FIG. 4, the first communication interface 42a may specifically include an input endpoint 421a and an output endpoint 422a. The input endpoint 421a is a first input interface in the first communication interface 42a that is configured to directly send input data information (for example, input operation information) of the peripheral device to the cloud application client by using the USB driver 43a. Similarly, the output endpoint 422a is a first output interface in the first communication interface 42a that is configured to receive feedback information sent from the cloud application client to the peripheral device. In other words, when the peripheral device is in the first service mode, the peripheral device may send the input data information of the peripheral device to the USB driver 43a of the terminal device through the first input interface in the first communication interface 42a, and then the cloud application client may directly obtain, from the USB driver 43a, the input data information uploaded by the peripheral device. In this case, the input data information does not need to be forwarded by the management component of the operating system. In some aspects, the peripheral device may further receive, by using the first output interface in the first communication interface 42a, feedback information (for example, device vibration feedback information) delivered by the terminal device in the first communication manner.

The first service mode of the peripheral device may be independent of the second service mode, or may be compatible with the second service mode. This is not limited herein. When the first service mode of the peripheral device is independent of the second service mode, if the peripheral device has not received feedback information (for example, device heartbeat feedback information, also referred to as a heartbeat packet) sent by the cloud application client, the peripheral device may switch the first service mode to the second service mode. In some aspects, in another implementation, when the first service mode of the peripheral device is compatible with the second service mode, if the peripheral device has not received device heartbeat feedback information sent by the cloud application client, the peripheral device may enable the second service mode in the first service mode.

In this disclosure, a prompt interface or a pop-up window can be displayed, or voice prompt information can be outputted before collecting data related to a service object and when collecting data related to a service object. The prompt interface, the pop-up window, or the voice prompt information is configured for prompting the service object that the data related to the service object is currently being collected. In this way, in this disclosure, related operations of obtaining the data related to the service object only start to be executed after obtaining a confirmation operation of the service object on the prompt interface or the pop-up window. Otherwise (that is, the confirmation operation of the service object on the prompt interface or the pop-up window is not obtained), the related operations of obtaining the data related to the service object are ended, that is, the data related to the service object is not obtained. In other words, in this disclosure, all collected service object data is collected with the consent and authorization of service objects. The collection, use, and processing of the data related to the service object need to comply with the relevant laws, regulations, and standards of relevant countries and regions.

The cloud server can be an independent physical server, or a server cluster including multiple physical servers, or a distributed system, and can also be a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal device includes but is not limited to a mobile phone, a computer, an intelligent voice interaction device, a smart home appliance, an in-vehicle terminal, an aircraft, a smart speaker, a smart home appliance, and the like.

Further, FIG. 5 is a schematic flowchart 1 of a data processing method according to an embodiment of this disclosure. The method may be performed by a peripheral device supporting a first communication protocol. For example, the peripheral device may be a gamepad. The method may include at least the following operation S501 and operation S502.

S501: Obtain first service data information associated with a peripheral device; the first service data information including input data structure information configured for representing an input service feature of the peripheral device, and the input data structure information including at least one or more of object operation data information, device attribute data information, and device battery strength data information.

The first service data information (also referred to as extended service data information) may be used for indicating a data structure for implementing a corresponding service feature based on the first communication protocol (also referred to as an extended communication protocol). The data structure herein refers to a manner in which a computer stores and organizes data, and may be a set of data elements having a structural feature.

The input service feature may be a service feature when the peripheral device sends (that is, transmits) corresponding data to the terminal device based on the first communication protocol. That is, the input service feature is a service feature of data inputted to the cloud application client through an input endpoint of a first communication interface for the cloud application client on the terminal device. The input service feature may include one or more of the following: a service feature that corresponds to the object operation data information and that is used for obtaining the input operation information, a service feature that corresponds to the device attribute data information and that is used for obtaining the device attribute, and a service feature that corresponds to the device battery strength data information and that is used for obtaining the device battery strength. The input data structure information is data structure information that is generated according to a structure (for example, the extended data structure) and that is for implementing data that needs to be transmitted for the input service feature. In other words, in this embodiment of this disclosure, data that needs to be transmitted for the input service feature may be collectively referred to as input data information. The input data information herein may specifically include one or more of obtained input operation information, an obtained device attribute, and an obtained device battery strength.

In some aspects, a cloud application started in the cloud application client may specifically include a cloud game, and the peripheral device includes a gamepad configured to control a game object displayed in the cloud game in the terminal device. The gamepad herein includes at least one or more operable components of a gamepad joystick, a gamepad key, a six-axis sensor, and a touchpad.

A specific implementation of obtaining the object operation data information may be described as: In response to a trigger operation performed by a service object on the peripheral device, the peripheral device may generate object operation data information based on input operation information corresponding to the trigger operation, and then use the generated object operation data information as the first service data information. A data structure corresponding to the object operation data information includes at least the following parameter fields: one or more of an axial parameter field of the gamepad, a key parameter field of the gamepad, a sensor parameter field of the gamepad, and a direction parameter field of the gamepad, the axial parameter field is used for indicating an operation value when the gamepad joystick is operated on each of N direction axes, N is a positive integer greater than or equal to 3, the key parameter field is used for indicating an operation key value of a key of the gamepad; the sensor parameter field is used for indicating a sensing value of the six-axis sensor on each of K coordinate axes, K is a positive integer greater than or equal to 6, and the K coordinate axes include an acceleration coordinate axis and an angular velocity coordinate axis; and the direction parameter field is used for indicating operation key values of the touchpad in M directions, where M is a positive integer greater than or equal to 4.

A game object in a cloud game may be a virtual person, a virtual animal, a virtual object (for example, a virtual vehicle), or the like that can be controlled in a virtual scene of the cloud game based on an operation performed by a service object. The virtual scene can be displayed on a terminal device when the cloud game runs, and the service object can control a game object to move in this virtual scenario. The virtual scene may be a simulated environment of a real world, or may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene, and the dimension of the virtual scene is not limited in the embodiments of this disclosure.

The gamepad is also referred to as a gamepad for gaming. The service object may control a game object in the cloud game by using an operable component of the gamepad, for example, one or more operable components of a gamepad joystick, a gamepad key, a six-axis sensor, and a touchpad.

The gamepad joystick may be pushed on multiple direction axes (that is, N direction axes). The gamepad may have at least one gamepad joystick. For ease of understanding, an example of two gamepad joysticks is used. In this case, the gamepad may include two gamepad joysticks: a left joystick and a right joystick. The left joystick herein may be a joystick that is located on one side (for example, a left side) of the body of the service object and that is determined by using the body of the service object as a reference point when the service object faces the peripheral device. Similarly, the right joystick herein may be a joystick that is located on the other side (a right side) of the body of the service object and that is determined by using the body of the service object as the reference point.

When a service object operates a gamepad joystick (for example, when the service object pushes the left joystick), an operation value on each of N direction axes may be generated, and operation values of the gamepad joystick (for example, the left joystick) in the direction axes all fall within a particular operation range (for example, 0 to 62235). Specifically, reference may be made to the following Table 1. N is a positive integer greater than or equal to 3. For example, the N direction axes may be x, y, and z axes of the gamepad joystick. Similarly, when the service object pushes the right joystick, operation values of the right joystick in the N direction axes may also be obtained, and the operation values of the right joystick in the direction axes also fall within a particular operation range (for example, 0 to 62235). Specifically, reference may be made to the following Table 1. In this embodiment of this disclosure, the gamepad may obtain operation values of the gamepad joystick in various directions as operation data.

The gamepad may include multiple gamepad keys. Specifically, reference may be made to the following Table 2. As shown in the following Table 2, the multiple gamepad keys on the gamepad may specifically include keys such as a steering wheel key (for example, A, B, Y, and X keys) of the gamepad, keys corresponding to the gamepad joysticks (for example, a left joystick press key and a right joystick press key), left and right shoulder keys (for example, an LB key and an RB key), a back key, a start key, a turbo key, and a shift key. This is not limited herein. As shown in the following Table 2, each gamepad key has a corresponding operation key value (also referred to as a key value of a key or a key value). In this way, when a service object presses a key, the gamepad may use an obtained key value of the key pressed by the service object as operation data.

The six-axis sensor, also referred to as a six-axis gyroscope, may include an accelerometer and a gyroscope. When the service object moves or rotates the gamepad, the gamepad may obtain a sensing value of the six-axis sensor on each of the K coordinate axes, and may further determine a sensing value of the gamepad on each of the K coordinate axes. In other words, in this embodiment of this disclosure, the gamepad may use obtained sensing values of the six-axis sensor on the coordinate axes as input operation information. Sensing values on the K coordinate axes all fall within a corresponding operation range (Specifically, reference may be made to sensing values of a six-axis gyroscope on corresponding coordinate axes provided in the following Table 3). The K coordinate axes may include acceleration coordinate axes (for example, acceleration x, y, and z axes), and angular velocity coordinate axes (for example, angular velocity x, y, and z axes).

Although the acceleration x, y, and z axes, the angular velocity x, y, and z axes, and the x, y, and z axes of the gamepad joystick are all referred to as x, y, and z axes, these axes may be direction axes in three-dimensional space coordinate systems established based on different origins (that is, different reference points) and different orientations. This is not limited herein.

The touchpad may be configured to obtain a touch operation or a press operation performed by the service object. For ease of understanding, an example in which the touch operation is a slide operation is used herein. When the service object performs the slide operation in different directions of the M directions on the touchpad, the gamepad may obtain an operation key value that exists when the service object slides in each direction on the touchpad, and operation key values that are obtained by the gamepad and that exist when the service object slides in different directions on the touchpad may be different from each other. For example, as shown in the foregoing Table 2, an operation key value (that is, a key value of a key) that exists when the service object slides upwards on the touchpad (that is, the service object slides upwards with a finger on the touchpad) may be 0x400 (a value represented in hexadecimal). For another example, an operation key value (that is, a key value of a key) that exists when the service object slides downwards on the touchpad (that is, the service object slides downwards with a finger on the touchpad) may be 0x800 (another value represented in hexadecimal). By analogy, operation key values (that is, key values of a key) that exist when the service object slides leftwards and/or rightwards on the touchpad (that is, the service object slides leftwards and/or rightwards with a finger on the touchpad) may be respectively 0x1000 and/or 0x2000. In other words, when the service object slides towards different directions on the touchpad, the gamepad may use operation key values (that is, key values of a key) obtained when the service object slides towards different directions as the input operation information. The slide operation herein may specifically include at least one of sliding upwards, sliding downwards, sliding leftwards, and sliding rightwards. That is, in this embodiment of this disclosure, the touchpad may be used as a reference point to define different directions of the M directions when the service object performs the slide operation on the touchpad.

Key values or operation ranges of the gamepad keys may be different according to different peripheral device manufacturers or different cloud applications running in the cloud application client. This is not limited herein. The purpose of each operable component of the gamepad depends on settings of the cloud game. Gamepads of different device models may include different operable components. This is not limited herein. For example, for descriptions of key values or operation ranges of different operable components on the gamepad, refer to the following tables (Table 1, Table 2, Table 3, and Table 4).

TABLE 1

| Direction axis | Operation range | Description |
|---|---|---|
| GD_PointerX | 0 to 65535 | Represent X axis of left joystick of gamepad |
| GD_PointerY | 0 to 65535 | Represent Y axis of left joystick of gamepad |
| GD_PointerRx | 0 to 65535 | Represent X axis of right joystick of gamepad |
| GD_PointerRy | 0 to 65535 | Represent Y axis of right joystick of gamepad |
| GD_PointerZ | 0 to 65535 | Represent LT key of gamepad |
| GD_PointerRz | 0 to 65535 | Represent RT key of gamepad |

In Table 1, the LT key is a left trigger key on the gamepad, and the RT key is a right trigger key on the gamepad. As shown in Table 1, the left trigger key on the gamepad and the left joystick of the gamepad are different physical control keys, and the right trigger key on the gamepad and the right joystick of the gamepad are also different physical control keys.

When a gamepad joystick (for example, a left joystick and/or a right joystick) is pushed in a corresponding direction axis, the game object may be controlled to move in a direction matching the direction axis. For example, when the service object moves a joystick (for example, the left joystick) on an X axis, the game object may be controlled to move in an X direction (for example, move between left and right) matching the X axis of the left joystick of the gamepad.

When the service object pushes a trigger key (for example, the left trigger key), the gamepad may obtain an operation value in a specific direction axis (for example, a direction axis named “Z” provided in Table 1, and the direction axis named “Z” may be used to refer to any one of the x axis, the y axis, and the z axis) when the service object pushes the left trigger key, and a corresponding game object in the cloud game may be then controlled to respond. For example, when the cloud game is a car racing game, the gamepad in the peripheral device may linearly control a game object (for example, a virtual vehicle) to accelerate or brake based on an operation value obtained when the service object pushes the left trigger key. In other words, in this embodiment of this disclosure, a larger pressing depth of a corresponding trigger key pressed by the service object in a particular direction axis indicates a larger operation value obtained by the gamepad, so that the virtual vehicle can be controlled to accelerate or brake in a direct proportional manner more rapidly. In different cloud games, functions performed by the left and right trigger keys may be different, and specific functions performed by the left and right trigger keys are not limited herein.

TABLE 2

| Gamepad key | Key value of key |
|---|---|
| A | 0x1 |
| B | 0x2 |
| X | 0x4 |
| Y | 0x8 |
| LB (left shoulder key) | 0x10 |
| RB (right shoulder key) | 0x20 |
| Back | 0x40 |
| Start | 0x80 |
| Left joystick press key | 0x100 |
| Right joystick press key | 0x200 |
| DPad up (touchpad goes upwards) | 0x400 |
| DPad down (touchpad goes downwards) | 0x800 |
| DPad left (touchpad goes leftwards) | 0x1000 |
| DPad Right (touchpad goes rightwards) | 0x2000 |
| Turbo | 0x4000 |
| SHIFT | 0x8000 |

TABLE 3

| Six-axis gyroscope-coordinate axis | Sensing value |
|---|---|
| GD_PointerVx (acceleration on x axis) | 0 to 65535 (32768 represents static, and 0 and 65535 |
| | represent an upper limit and a lower limit of the range) |
| GD_PointerVy (acceleration on y axis) | 0 to 65535 (32768 represents static, and 0 and 65535 |
| | represent an upper limit and a lower limit of the range) |
| GD_PointerVZ (acceleration on z axis) | 0 to 65535 (32768 represents static, and 0 and 65535 |
| | represent an upper limit and a lower limit of the range) |
| GD_PointerVbrx (angular velocity on | 0 to 65535 (32768 represents static, and 0 and 65535 |
| x axis) | represent an upper limit and a lower limit of the range) |
| GD_PointerVbry (angular velocity on | 0 to 65535 (32768 represents static, and 0 and 65535 |
| y axis) | represent an upper limit and a lower limit of the range) |
| GD_PointerVbrz (angular velocity on | 0 to 65535 (32768 represents static, and 0 and 65535 |
| z axis) | represent an upper limit and a lower limit of the range) |

TABLE 4

| Steering wheel key | Key value of key |
|---|---|
| A | 0x1 |
| B | 0x2 |
| X | 0x4 |
| Y | 0x8 |
| L1 (left first key) | 0x10 |
| R1 (right first key) | 0x20 |
| L2 (left second key) | 0x40 |
| R2 (right second key) | 0x80 |
| SHARE | 0x100 |
| OPTIONS | 0x200 |
| MODE | 0x400 |
| L3 | 0x800 |
| R3 | 0x1000 |
| Left butterfly wing | 0x2000 |
| Right butterfly wing | 0x4000 |

When the service object performs a trigger operation on the gamepad, for example, presses a key of the gamepad, pushes a joystick of the gamepad, or rotates a direction of the gamepad, it may be determined that operation data corresponding to the trigger operation is collectively referred to as input operation information corresponding to the trigger operation. In other words, the input operation information herein may specifically include one or more of operation data such as a key value of a gamepad key pressed by the service object, operation values of a gamepad joystick pushed by the service object in various direction axes, and sensing values (such as accelerations or angular velocities) of a six-axis gyroscope in the gamepad rotated by the service object in various coordinate axes. Further, the peripheral device may generate the object operation data information based on the input operation information corresponding to the trigger operation. In this case, the data structure corresponding to the object operation data information may include at least one of an axial parameter field of the gamepad, a key parameter field of the gamepad, a sensor parameter field of the gamepad, and a direction parameter field of the gamepad. The axial parameter field of the gamepad is used for indicating an operation value when a joystick of the gamepad (that is, the left joystick and/or the right joystick of the gamepad) is operated in each of the N direction axes in Table 1. In addition, the axial parameter field of the gamepad is further used for indicating an operation value when a trigger key of the gamepad (that is, the left trigger key and/or the right trigger key of the gamepad) is operated in each of the N direction axes in Table 1. The key parameter field is used for indicating an operation key value of the gamepad key in Table 2. The sensor parameter field is used for indicating a sensing value of the six-axis sensor on each of the K coordinate axes in Table 3. The direction parameter field is used for indicating an operation key value when the service object slides towards each of M directions on the touchpad in Table 2. For example, the following is an example of a data structure corresponding to one piece of object operation data information:

```
  typedef struct GamepadInputReport {
  uint8_treportId;
  uint16_tGD_PointerX;
  uint16_tGD_PointerY;
  uint16_tGD_PointerRx;
  uint16_tGD_PointerRy; //an axial parameter field corresponding to a gamepad
joystick;
  uint16_tGD_PointerZ;
  uint16_tGD_PointerRz; //an axial parameter field corresponding to a trigger key
of a gamepad;
  uint16_tGD_PointerVx;
  uint16_tGD_Pointer Vy;
  uint16_tGD_PointerVZ;
  uint16_tGD_PointerVbrx;
  uint16_tGD_PointerVbry;
  uint16_tGD_PointerVbrz; //a sensor parameter field corresponding to a six-axis
gyroscope
  uint16_tBTN_GamepadButton; //a direction parameter field corresponding to a
touchpad
  uint16_tSC_SimCtrlsBrake;
  uint16_tSC_SimCtrlsAccelerator;
  uint8_tGD_HatSwitch; //a key parameter field corresponding to a gamepad key
  uint16_tBTN_SteerWheelBuuton; //a key parameter field corresponding to a
gamepad steering wheel
  } GamepadInputReport;
```

In the data structure corresponding to the object operation data information, the axial parameter field of the gamepad may specifically include an axial parameter field (for example, a GD_PointerX field, a GD_PointerY field, a GD_PointerRx field, and a GD_PointerRy field) corresponding to a joystick of the gamepad and an axial parameter field (for example, a GD_PointerZ field and a PointerRz field) corresponding to a trigger key of the gamepad. As shown in Table 1, the GD_PointerX field is used to represent the X axis of the left joystick of the gamepad, and a field value of the GD_PointerX field is used to describe an operation value when the joystick of the gamepad is operated on each of N direction axes. Similarly, for specific interpretation of other fields of the axial parameter fields of the gamepad, reference may be made to the description of the specific interpretation of the GD PointerX field in Table 1. Examples are not listed one by one herein.

Similarly, in the data structure corresponding to the object operation data information, the sensor parameter field of the gamepad is specifically a sensor parameter field (for example, a GD_PointerVx field, a GD_PointerVy field, a GD_PointerVZ field, a GD_PointerVbrx field, a GD_PointerVbry field, and a GD_PointerVbrz field) corresponding to the six-axis sensor in the gamepad. For ease of understanding, the GD_PointerVx field of the sensor parameter field is used as an example herein to describe specific interpretation of the GD PointerVx field. For example, as shown in Table 3, the GD_PointerVx field is used to represent an acceleration on the x axis, and a field value of the GD_PointerVx field is used to describe a sensing value of an accelerometer of the six-axis sensor on a corresponding coordinate axis (for example, the x axis) when a service object rotates the gamepad (for example, a gravity acceleration of accelerations of the accelerometer on the x axis of the acceleration coordinate axes).

The key parameter field corresponding to the gamepad key may specifically include an SC SimCtrlsBrake field (that is, a control key used for representing braking), an SC SimCtrlsAccelerator field (that is, a control key used for representing acceleration), and a GD_HatSwitch (that is, a control key used for representing switching).

In some aspects, a specific process of obtaining the device attribute data information associated with the peripheral device may be described as follows: When receiving a device attribute query instruction delivered by the cloud application client by using the first output interface indicated by the first communication protocol, the peripheral device queries a device attribute of the peripheral device based on the device attribute query instruction. Further, the peripheral device generates device attribute data information according to the queried device attribute, and then may determine the generated device attribute data information as the first service data information. A data structure corresponding to the device attribute data information includes at least the following parameter fields: a manufacturer parameter field of the peripheral device, a device model parameter field of the peripheral device, a firmware parameter field of the peripheral device, a sensor parameter field of the peripheral device, and a service feature parameter field of the peripheral device; the manufacturer parameter field is used for indicating a manufacturer serial number of the peripheral device; the device model parameter field is used for indicating a device model of the peripheral device; the firmware parameter field is used for indicating a firmware building time of the peripheral device; the sensor parameter field is used for indicating a measurement range or a sampling frequency of a six-axis sensor of the peripheral device, and the service feature parameter field is used for indicating a service feature supported by the peripheral device.

The device attribute query instruction may be used to obtain the device attribute of the peripheral device. The device attribute of the peripheral device may specifically include a manufacturer serial number of the peripheral device, a device model of the peripheral device, a firmware building time of the peripheral device, and a measurement range and/or a sampling frequency of a six-axis sensor in the peripheral device.

The device attribute query instruction may be generated by the cloud server. That is, the cloud server may send the device attribute query instruction to the cloud application client, and then the cloud application client delivers the device attribute query instruction to the peripheral device based on the first communication protocol. For example, in a cloud game scenario, a service object may trigger, by using a gamepad, a control used for querying the device attribute, the virtual cloud client may generate the device attribute query instruction in response to the trigger operation performed on the control used for querying the device attribute, and send the device attribute query instruction to the cloud application client of the terminal device. The cloud application client then delivers the device attribute query instruction to the peripheral device based on the first communication protocol.

The manufacturer serial number may be an authenticated number of a manufacturer that produces the peripheral device, and may uniquely identify a manufacturer. The device model may be a serial number determined by a manufacturer based on a requirement and a specification of the peripheral device. The firmware may be underlying code connecting hardware and an operating system when a computer is started. The firmware building time is used for indicating a time stamp for building the firmware of the peripheral device, and may be represented in a millisecond format. A measurement range (also referred to as a range) of the six-axis sensor may include a range (a unit may be dps) of a gyroscope and a range (a unit may be g) of an accelerometer in the six-axis sensor. As shown in Table 3, the gyroscope in the six-axis sensor may be configured to measure angular velocities on the angular velocity x, y, and z axes, and the accelerometer in the six-axis sensor may be configured to measure gravity accelerations on the acceleration x, y, and z axes. The sampling frequency of the six-axis sensor is used for indicating a frequency (a unit may be HZ) of collecting an acceleration or an angular velocity on each coordinate axis. The service feature may include the input service feature supported by the peripheral device. The input service feature may specifically include a service feature used for querying a device battery strength, a service feature used for obtaining operation data (that is, the input data information) of a service object, and the like. For example, the following is an example of a data structure corresponding to device attribute data information:

```
  typedef struct VendorInfoInputReport {
  uint8_treportId;
  uint8_t version;
  uint16_tvendorType; //a manufacturer parameter field corresponding to a
manufacturer serial number
  uint16_tproductType; //a device model parameter field corresponding to a device
model
  uint64_tfeatureSupport; //a service feature parameter field corresponding to a
service feature supported by hardware
  uint16_tgyroscopeRange; //a sensor parameter field corresponding to an angular
velocity range of a gyroscope
  uint8_tgyroscopeRate; //a sensor parameter field corresponding to a sampling
frequency of a gyroscope
  uint8_taccelerateRange; //a sensor parameter field corresponding to a range of an
accelerometer
  uint8_taccelerateRate; //a sensor parameter field corresponding to a sampling
frequency of an accelerometer
  uint64_tbuildTime; //a firmware parameter field corresponding to a firmware
building timestamp
  uint8_tuuid[16];
  }VendorInfoInputReport;
```

In some aspects, a specific process of obtaining the battery strength data information associated with the peripheral device may be described as follows: The peripheral device may actively generate, when detecting that a device battery strength of the peripheral device decreases to a battery strength threshold, the device battery strength data information based on the detected device battery strength, and determine the generated device battery strength data information as the first service data information. A data structure corresponding to the device battery strength data information includes at least the following parameter field: a device battery strength parameter field, and the device battery strength parameter field is used for indicating a battery strength value of a device battery strength of the peripheral device.

A value of the device battery strength may be represented as a percentage of a current battery strength of the peripheral device in a full battery strength of the peripheral device (that is, a percentage of the current battery strength in the full battery strength). For example, if a current battery strength of the peripheral device is 48% of a full battery strength, when the full battery strength of the peripheral device is 100, a value of the current battery strength of the peripheral device may be 48.

The battery strength threshold may be a preset device battery strength for triggering the peripheral device to actively send battery strength information to the cloud application client. For example, the battery strength threshold may be 20. When a value of the device battery strength of the peripheral device decreases to 20 as the peripheral device is used, the peripheral device may generate device battery strength data information based on the detected device battery strength. For example, the following is an example of a data structure corresponding to device battery strength data information:

```
  typedef struct GamepadBSInputReport {
  uint8_treportId;
  uint8_tGEN_GamePadBatteryStrength; //a device battery strength
parameter field corresponding to a device battery strength
  } GamepadBSInputReport;
```

In some aspects, a specific process of obtaining the device battery strength data information associated with the peripheral device further may be described as follows: When receiving a battery strength query instruction delivered by the cloud application client by using the first output interface indicated by the first communication protocol, the peripheral device may query a device battery strength of the peripheral device based on the battery strength query instruction, generate device battery strength data information based on the queried device battery strength, and then determine the generated device battery strength data information as the first service data information. A data structure corresponding to the device battery strength data information includes at least the following parameter field: a device battery strength parameter field, and the device battery strength parameter field is used for indicating a battery strength value of a device battery strength of the peripheral device.

The battery strength query instruction is used for instructing to query a device battery strength of the peripheral device. The battery strength query instruction may be periodically generated by the cloud server. For example, the cloud server may generate the battery strength query instruction at intervals (for example, 1 minute), or may generate the battery strength query instruction in response to an operation of the service object. This is not limited herein.

After the cloud server sends the generated battery strength query instruction to the cloud application client, the cloud application client may then send the battery strength query instruction to the peripheral device based on the first communication protocol (which may be specifically the first output interface indicated by the first communication protocol).

As described above, the input service feature may include one or more of the following: a service feature that corresponds to the object operation data information and that is used for obtaining the input operation information, a service feature that corresponds to the device attribute data information and that is used for obtaining the device attribute, and a service feature that corresponds to the device battery strength data information and that is used for obtaining the device battery strength. The peripheral device in this embodiment of this disclosure is further configured to perform the following operation: receiving, by the peripheral device, a device scanning instruction delivered by the cloud application client on the terminal device by using the first output interface indicated by the first communication protocol. Further, the peripheral device may obtain, based on the device scanning instruction, first interface information supported by the peripheral device, and return the first interface information to the cloud application client by using the first input interface indicated by the first communication protocol. The first interface information includes at least one or more of the following interface information: first object operation data interface information corresponding to the object operation data information, first attribute obtaining interface information corresponding to the device attribute data information, and first battery strength obtaining interface information corresponding to the device battery strength data information. Further, when receiving a device feature query instruction delivered by the cloud application client for the first interface information through the first output interface, the peripheral device queries, based on the device feature query instruction, a first service feature supported by the peripheral device, and returns the first service feature to the cloud application client through the first input interface indicated by the first communication protocol, where the first service feature includes the input service feature.

The device scanning instruction is used to instruct to obtain first interface information supported by the peripheral device. The first interface information (also referred to as extended interface information) may be information of an interface that is used for implementing a corresponding service feature and that is supported when data is transmitted based on the first communication protocol (also referred to as an extended communication protocol). The interface indicated by the first interface information herein may be a software interface. The software interface may be a class or a function that is in a program and that is specifically responsible for transmitting or receiving data between different modules and performing processing. The first interface information herein may include an interface name of the first interface.

The first interface information (that is, interface information of first object operation data) corresponding to the object operation data information may be specifically a software interface whose interface name is GamepadInputReport( ) in the data structure corresponding to the object operation data information. The first interface information (that is, first attribute obtaining interface information) corresponding to the device attribute data information may be specifically a software interface whose interface name is VendorInfoInputReport( ) in the data structure corresponding to the device attribute data information. The first interface information (that is, first battery strength obtaining interface information) corresponding to the device battery strength data information may be specifically a software interface whose interface name is GamepadBSInputReport( ) in the data structure corresponding to the device battery strength data information.

In some aspects, in this embodiment of this disclosure, the device scanning instruction may alternatively be delivered, based on the first output interface indicated by the first communication protocol, by the cloud application client when the cloud application client starts the cloud application. Subsequently, when the peripheral device obtains the first service data information, only the first service data information that corresponds to the first interface information supported by the peripheral device is valid.

The device feature query instruction may be used to query a first service feature (also referred to as an extended service feature) supported by the peripheral device. The first service feature may be used for indicating a service feature supported by the peripheral device when communicating based on the first communication protocol. The first service feature may include an input service feature, or may include a feedback service feature.

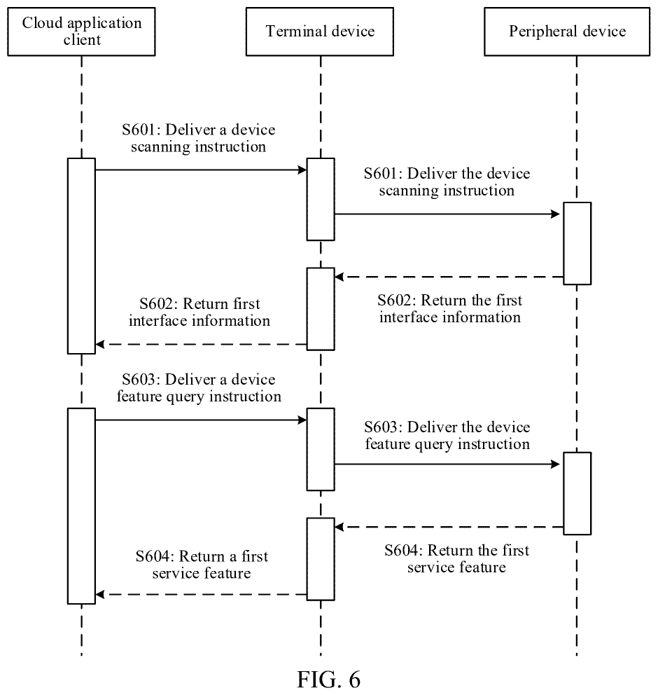

For example, FIG. 6 is a schematic flowchart of querying a service feature supported by a peripheral device according to an embodiment of this disclosure. A cloud application client shown in FIG. 6 may run in a terminal device shown in FIG. 6. For ease of understanding, the cloud application client and the terminal device are abstractly represented as two parts in this embodiment of this disclosure. As shown in FIG. 6, a query process of querying a service feature supported by a peripheral device mainly involves a cloud application client, a terminal device, and the peripheral device. Specifically, as shown in FIG. 6, when performing operation S601, the cloud application client may generate a device scanning instruction, and then perform operation S601 through the terminal device (specifically, through a USB driver in the terminal device) based on the first communication protocol, to send the device scanning instruction to the peripheral device by using the first output interface.

As shown in FIG. 6, after receiving the device scanning instruction, the peripheral device may obtain the first interface information supported by the peripheral device, and may perform operation S602 shown in FIG. 6, to send the first interface information to the cloud application client through the terminal device (specifically, through the USB driver in the terminal device).

Further, the cloud application client may perform operation S603 shown in FIG. 6, generate a device feature query instruction for the first interface information, and deliver the device feature query instruction to the peripheral device through the terminal device (specifically, through the USB driver in the terminal device) based on the first communication protocol.

Further, after receiving the device feature query instruction, the peripheral device may obtain the first service feature supported by the peripheral device (for example, the service feature used for obtaining a device battery strength, the service feature used for obtaining a device attribute, and the service feature used for obtaining input data information), and then perform operation S604 shown in FIG. 6, to send the queried first service feature to the cloud application client through the terminal device (specifically, through the USB driver in the terminal device).

When the cloud application client starts the cloud application, the service mode of the peripheral device may be switched from the second service mode to the first service mode. Specifically, the peripheral device may receive a mode switching instruction delivered by the cloud application client based on the first communication protocol when a cloud application is started, and switch the service mode of the peripheral device from the second service mode to the first service mode based on the mode switching instruction, where the first service mode is used for instructing the peripheral device to perform data transmission with the cloud application client based on the first communication protocol.

In some aspects, when the cloud application client starts the cloud application, the cloud application client sends the device scanning instruction shown in FIG. 6 to the peripheral device based on the first communication protocol. In this way, when receiving the device scanning instruction, the peripheral device may switch the service mode of the peripheral device from the second service mode to the first service mode based on the device scanning instruction. When the first service mode of the peripheral device is independent of the second service mode, if the peripheral device receives the mode switching instruction or the device scanning instruction, the peripheral device may switch the second service mode to the first service mode, so as to facilitate data transmission between the peripheral device and the cloud application client based on the second communication manner. In some aspects, in another implementation, when the first service mode of the peripheral device is compatible with the second service mode, if the peripheral device receives the mode switching instruction or the device scanning instruction, the peripheral device may no longer enable the second service mode compatible with the first service mode, and perform data transmission based on the first communication protocol.

S502: Upload the first service data information to a cloud application client by using a first input interface indicated by the first communication protocol, so that the cloud application client transmits the first service data information to a virtual cloud client corresponding to the cloud application client, the virtual cloud client herein running in a cloud server. In this case, the first service data information is configured to instruct the cloud server to identify a data structure type of the first service data information when the virtual cloud client supports the first communication protocol, and when identifying that the data structure type of the first service data information is a first data structure type, instruct the cloud server to parse the first service data information to obtain input data information indicated by the input data structure information, and instruct the cloud server to obtain media data information that corresponds to the input data information and that is to be returned to the cloud application client, and the cloud application client being configured to output the media data information corresponding to the input data information.

The first data structure type may include a data structure type indicated by the object operation data information, a data structure type indicated by the device attribute data information, a data structure type indicated by the device battery strength data information, and the like. Input data structure information corresponding to the first data structure type may be understood as a data structure corresponding to an interface indicated by the first interface information.

When the input structural data information includes the object operation data information, input data information obtained by parsing by the virtual cloud client of the cloud server may include the input operation information. In this case, the virtual cloud client may render based on the input operation information, to obtain an application display image, so as to use, as media data information corresponding to the input data information, the application display image obtained through rendering based on the input operation information. For example, in a cloud game scenario, when a service object performs a game operation by using a gamepad, input operation information corresponding to the game operation obtained by the peripheral device may specifically include an operation key value of a gamepad key used for controlling the game object to move leftwards (the operation key value herein is specifically a key value obtained when the service object presses a gamepad key on the gamepad). In this way, when obtaining the input operation information in the input data information through parsing, the virtual cloud client may quickly obtain the operation key value of the gamepad key used for controlling the game object to move leftwards, then generate a game image (that is, an application display image) in which the game object moves leftwards, then generate media data information based on the game image obtained through rendering, and then send the media data information to the cloud application client for presentation.

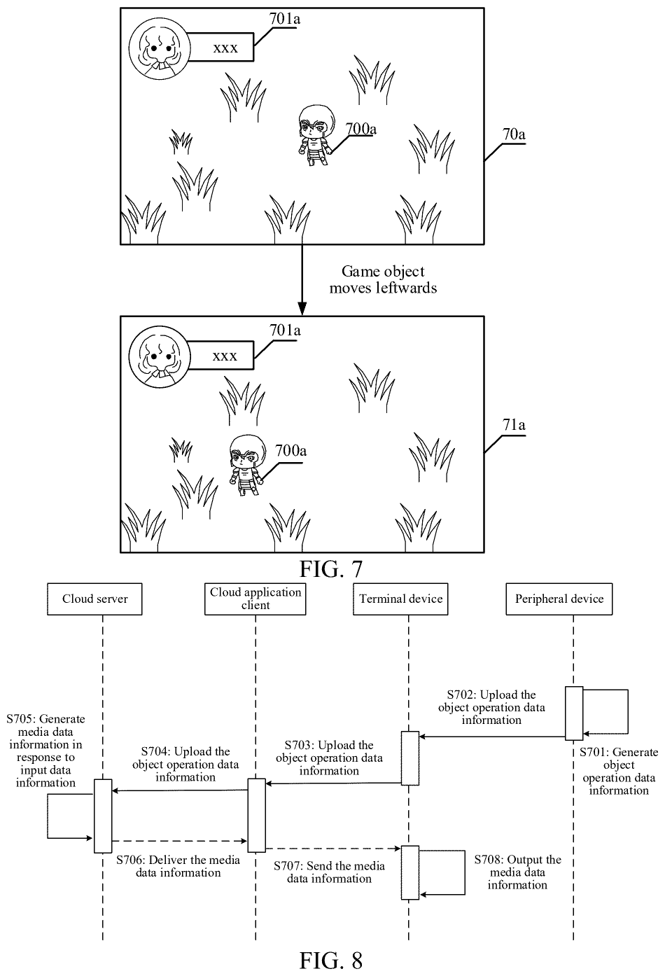

For example, FIG. 7 is a schematic diagram of an effect of displaying media data information according to an embodiment of this disclosure. As shown in FIG. 7, in a cloud game scenario, object information 701a of a service object may be displayed in a game image, for example, information such as a name, an energy value, and a level of the service object may be displayed, or a game object 700a controlled by the service object may be displayed. When the service object controls, by using the gamepad, the game object 700a to move leftwards, input data information (for example, input operation information) of a peripheral device may include an operation key value of a gamepad key used for controlling the game object to move leftwards. In this case, when parsing the first service data information to obtain the input data information indicated by the input data structure information, the cloud server may further generate, based on the input data information obtained through parsing, a game image (that is, an application display image, where the application display image herein may be a game image 71a shown in FIG. 7) used for moving the game object leftwards, so that the game object 700a moves from a position in a game image 70a to a position in the game image 71a, thereby controlling the game object to move leftwards by operating a gamepad key of the gamepad.

For ease of understanding, a specific process of uploading the object operation data information is described herein with reference to a figure. Further, FIG. 8 is a schematic flowchart of uploading object operation data information according to an embodiment of this disclosure. As shown in FIG. 8, a peripheral device may perform operation S701 shown in FIG. 8 in response to a trigger operation performed by a service object, to generate object operation data information based on input operation information (for example, the foregoing operation key value of the gamepad key used for controlling the game object to move leftwards) corresponding to the trigger operation. Further, as shown in FIG. 8, when performing operation S702, the peripheral device may send the object operation data information to a terminal device (specifically, a USB driver in the terminal device). In this way, the USB driver in the terminal device may further perform operation S703, to directly send the object operation data information to the cloud application client. As can be seen, the peripheral device may directly send the object operation data information to the cloud application client through the terminal device (which is specifically the USB driver in the terminal device) based on the first communication protocol.

The cloud application client shown in FIG. 8 also runs in the terminal device. In this way, the cloud application client running in the terminal device may further perform operation S704, to send the object operation data information to a cloud server. A virtual cloud client corresponding to the cloud application client runs in the cloud server herein.

Further, as shown in FIG. 8, when the currently received object operation data information is parsed to obtain the input data information (for example, the input operation information), the virtual cloud client running in the cloud server may further perform operation S705. That is, the virtual cloud client may generate audio and video data of the cloud application (for example, the cloud game) in response to the input data information (for example, the input operation information) obtained through parsing, use the generated audio and video data as media data information corresponding to the input data information, and then perform operation S706. That is, the virtual cloud client may deliver the media data information to the cloud application client based on the first communication protocol, so that the cloud application client may further perform operation S707 to send the media data information to the terminal device. The media data information herein includes audio data and video data in the audio and video data. Therefore, when performing operation S708 (that is, outputting the media data information), while displaying the video data (that is, the application display image) of the cloud application (for example, a cloud game) in the cloud application client, the terminal device may synchronously play the audio data corresponding to the video data (that is, the application display image), to ensure that audio and images of the cloud game are synchronized. In other words, when supporting the first communication protocol, the virtual cloud client in this embodiment of this disclosure may send the media data information to the cloud application client, so that the terminal device on which the cloud application client runs may output the media data information.

When the input structure data information includes device attribute data information, input data information indicated by the input data structure information obtained by the cloud server by parsing the first service data information may specifically include a device attribute of the peripheral device. Then, the virtual cloud client may perform rendering based on the obtained device attribute to obtain a game image (that is, an application display image). Therefore, game images (that is, application display images) obtained by performing rendering based on the device attribute are collectively referred to as media data information.

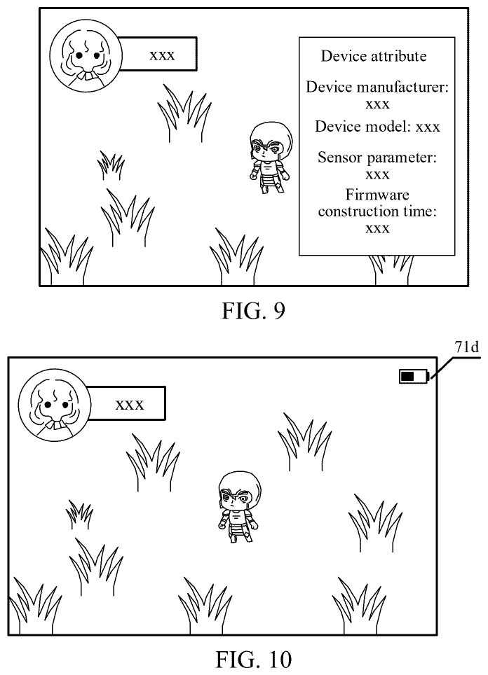

In some aspects, the device attribute of the peripheral device may be displayed in the game image (that is, an application display image) obtained through rendering based on the device attribute. For example, in a cloud game application scenario, a game image obtained through rendering by the cloud server may include the device attribute of the peripheral device (for example, a gamepad). Further, after the cloud server sends media data information corresponding to the device attribute to the cloud application client, the cloud application client may display the game image including the device attribute. For example, FIG. 9 is a schematic diagram of an effect of displaying another type of media data information according to an embodiment of this disclosure. As shown in FIG. 9, a terminal device may display a device attribute of a peripheral device in a game image of a cloud game running in a cloud application client, for example, attribute information such as a device manufacturer, a device model, a sensor parameter, and a firmware building time.

The device manufacturer herein is a manufacturer indicated by a manufacturer serial number of the peripheral device. The sensor parameter herein is a measurement range and/or a sampling frequency of a six-axis sensor in the peripheral device, and may be specifically, for example, an angular velocity range of a gyroscope, a sampling frequency of a gyroscope, a range of an accelerometer, and a sampling frequency of an accelerometer.

When the input structure data information includes device battery strength data information, input data information indicated by the input data structure information obtained by the cloud server by parsing the first service data information may specifically include a device battery strength of the peripheral device. Then, the virtual cloud client may perform rendering based on the obtained device battery strength to obtain a game image (that is, an application display image). Therefore, game images (that is, application display images) obtained by performing rendering based on the device battery strength are collectively referred to as media data information.

In some aspects, the device battery strength of the peripheral device may be displayed in the game image (that is, an application display image) obtained through rendering based on the device battery strength. For example, in a cloud game application scenario, a game image obtained through rendering by the cloud server may include the device battery strength of the peripheral device (for example, a gamepad). Further, after the cloud server sends media data information corresponding to the device battery strength to the cloud application client, the cloud application client may display the game image including the device battery strength. For example, FIG. 10 is a schematic diagram of an effect of displaying another type of media data information according to an embodiment of this disclosure. As shown in FIG. 10, a terminal device may display a device battery strength of a peripheral device in a game image of a cloud game running in a cloud application client. Specifically, as shown in FIG. 10, a battery strength icon 71d of a device battery strength may be displayed in a game image of the terminal device, so that a service object may learn a current device battery strength of the peripheral device based on the battery strength icon 71d. In some aspects, the service object may hide the battery strength icon of the device battery strength through the terminal device in a game process. In this way, when the service object needs to query the device battery strength of the peripheral device or the device battery strength of the peripheral device decreases to the foregoing battery strength threshold, the terminal device displays the battery strength icon of the current queried device battery strength or the battery strength icon of the current device battery strength that decreases to the battery strength threshold.

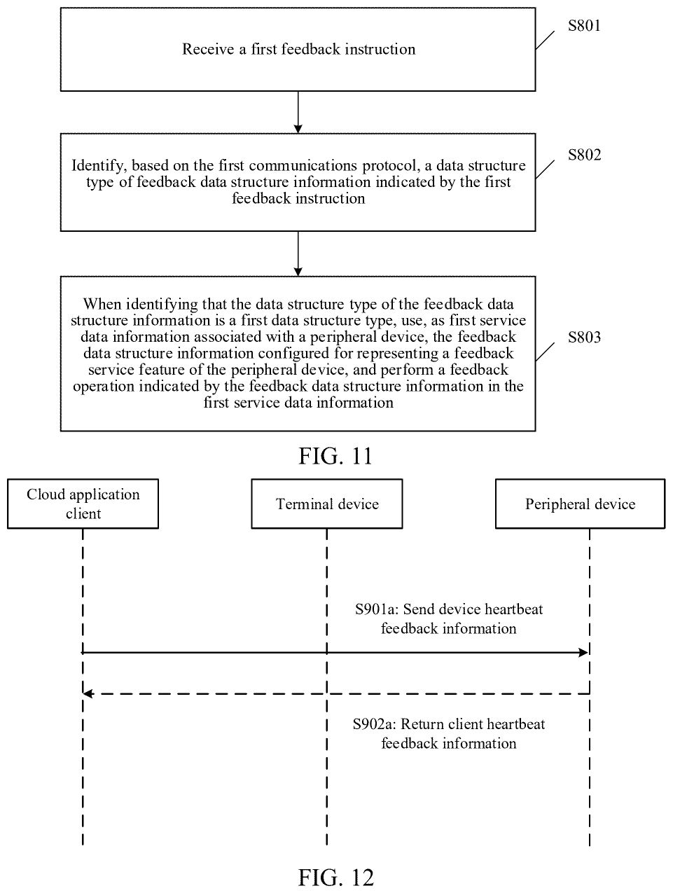

FIG. 11 is a schematic flowchart 2 of a data processing method according to an embodiment of this disclosure. The method may be performed by a peripheral device supporting a first communication protocol (as shown in 10c in FIG. 1). For example, the peripheral device may be a gamepad. The method may include at least the following operation S801 to operation S803

S801: Receive a first feedback instruction; the first feedback instruction being delivered by a cloud application client by using a first output interface indicated by the first communication protocol.

The first feedback instruction (also referred to as an extended feedback instruction) is a feedback instruction sent by the cloud application client to the peripheral device based on the first communication protocol. The feedback instruction may specifically include a device vibration feedback instruction and/or a device heartbeat feedback instruction. The device vibration feedback instruction is used to instruct the peripheral device to perform vibration feedback, and the device heartbeat feedback instruction is used to instruct the peripheral device to perform heartbeat feedback.

S802: Identify, based on the first communication protocol, a data structure type of feedback data structure information indicated by the first feedback instruction.

Feedback data structure information indicated by the first feedback instruction (also referred to as an extended feedback instruction) may be data structure information generated according to a specific structure based on data that needs to be transmitted for implementing a feedback service feature. A data structure type of the feedback data structure information may be used for indicating whether the feedback data structure information is a first data structure type, and the feedback data structure information of the first data structure type may include the device heartbeat feedback information, the device vibration feedback information, and the like.

S803: When identifying that the data structure type of the feedback data structure information is a first data structure type, use, as first service data information associated with the peripheral device, the feedback data structure information configured for representing a feedback service feature of the peripheral device, and perform a feedback operation indicated by the feedback data structure information in the first service data information.

The feedback data structure information includes at least one or more of device heartbeat feedback information and device vibration feedback information of the peripheral device. The feedback operation herein is specifically a vibration feedback operation when the peripheral device performs vibration feedback and/or an operation when the peripheral device performs heartbeat feedback.

The feedback service feature may be a service feature that exists when the terminal device sends (that is, transmits) corresponding data (that is, feedback information configured to instruct the peripheral device to perform a feedback operation) to the peripheral device based on the first communication protocol. That is, the feedback service feature is a service feature of data (that is, the feedback information configured to instruct the peripheral device to perform the feedback operation) outputted by the cloud application client on the terminal device through an output endpoint of a first communication interface. The feedback service feature may include one or more of the following: a service feature that is used to feed back a device heartbeat and that corresponds to the device heartbeat feedback information, and a service feature that is used to control a device vibration and that corresponds to the device vibration feedback information.

The feedback operation herein may be an operation performed by the peripheral device based on the feedback data structure information after obtaining the feedback data structure information. For example, the feedback operation may be a vibration feedback operation (also referred to as a vibration operation) performed by the peripheral device based on the device vibration feedback information. For another example, the feedback operation may be an operation that is performed by the peripheral device based on the device heartbeat feedback information and that is used for returning client heartbeat feedback information to the cloud application client. The feedback data structure information herein may be used as the first service data information (also referred to as extended service data information). Therefore, with reference to the foregoing content, the first service data information may specifically include object operation data information, device attribute data information, device battery strength data information, device heartbeat feedback information, device vibration feedback information, and the like.

The first feedback instruction corresponding to the device heartbeat feedback information is a device heartbeat feedback instruction generated, based on an operating system type of an operating system of the terminal device running the cloud application client, by the application client when a heartbeat feedback condition is triggered; a data structure corresponding to the device heartbeat feedback information includes at least a heartbeat signal parameter field, the heartbeat signal parameter field is a heartbeat signal corresponding to the operating system type of the operating system of the terminal device, and different operating system types are associated with corresponding heartbeat signals.

In this case, the feedback operation performed by the peripheral device may be specifically described as: When the feedback data structure information includes the device heartbeat feedback information, the peripheral device may obtain client heartbeat feedback information corresponding to the device heartbeat feedback information, where the client heartbeat feedback information belongs to the first service data information. The client heartbeat feedback information includes at least the heartbeat signal parameter field. Further, the peripheral device may upload the client heartbeat feedback information to the cloud application client by using the first input interface indicated by the first communication protocol, to complete a heartbeat feedback operation when the feedback data structure information includes the device heartbeat feedback information.

The heartbeat feedback condition may be a condition required for generating the first feedback instruction corresponding to the device heartbeat feedback information. For ease of understanding, in this embodiment of this disclosure, the first feedback instruction corresponding to the device heartbeat feedback information may be referred to as a device heartbeat feedback instruction. That is, in this embodiment of this disclosure, when device heartbeat feedback instructions corresponding to the device heartbeat feedback information is generated, generated device heartbeat feedback instructions may be collectively referred to as the first feedback instruction. In some aspects, the heartbeat feedback condition may be a condition when a time difference between a current time and a time for previously sending the device heartbeat feedback instruction reaches a time threshold (that is, a target time threshold, for example, 2s). The current time may be a system time of the terminal device, that is, the device heartbeat feedback instruction may be sent at intervals (for example, 2s).

The heartbeat signal parameter field may be used for indicating a heartbeat signal that needs to be sent. For terminal devices having operating systems of different operating system types, different heartbeat signals need to be obtained, and different operating system types may correspond to different heartbeat signals. For example, as shown in the following Table 5, the operating system type of the operating system of the terminal device may specifically include any one of Windows, Android, Linux, MacOS, and the like. This is not limited herein. In some aspects, the heartbeat signal may be represented as an array, for example, may be an array having a length of 4. For example, the following table (Table 5) provides an example of a heartbeat signal corresponding to each operating system type.

TABLE 5

| Operating system type | Description of heartbeat signal |
|---|---|
| Windows | heartbeatSerial[4]: 01 01 01 01 |
| Android | heartbeatSerial[4]: 02 02 02 02 |
| Linux | heartbeatSerial[4]: 03 03 03 03 |
| MacOS | heartbeatSerial[4]: 04 04 04 04 |

As described above, a data structure indicated by the device heartbeat feedback information may include a heartbeat signal parameter field. For example, the following is an example of a data structure corresponding to one piece of device heartbeat feedback information:

```
  typedef struct HeartBeatOutputReport {
  uint8_treportId;
  uint8_theartbeat [4]; //a heartbeat signal parameter field corresponding
to a heartbeat signal
  } HeartBeatOutputReport;
```

In this embodiment of this disclosure, based on an operating system type (for example, Windows in Table 5) of an operating system of the terminal device on which the cloud application client currently runs, the cloud application client may write, into a data structure corresponding to the device heartbeat feedback information, a heartbeat signal parameter field (for example, a heartbeat [4] field used to represent an array having a length of 4) corresponding to a heartbeat signal that the cloud application client expects to obtain. In this way, the cloud application client may send the device heartbeat feedback information of a specific data structure (that is, the foregoing extended data structure) to the peripheral device based on the first communication protocol by using the USB driver in the terminal device. In other words, when obtaining the device heartbeat feedback information sent by the cloud application client by using the first output interface, the peripheral device may perform a heartbeat feedback operation indicated by the device heartbeat feedback information, and then may return a heartbeat signal to the cloud application client when performing the heartbeat feedback operation. That is, in this case, the peripheral device may write, into a data structure (that is, the foregoing extended data structure) corresponding to the client heartbeat feedback information, a heartbeat signal parameter field (for example, a heartbeat [4] field used to represent an array having a length of 4) corresponding to a heartbeat signal that needs to be returned for the cloud application client, so that the peripheral device may send the client heartbeat feedback information of the specific data structure to the cloud application client based on the first communication protocol by using the USB driver in the terminal device, thereby ensuring that the cloud application client and the peripheral device can maintain a connection based on the first communication protocol.

The client heartbeat feedback information may be data structure information that is generated by the peripheral device after receiving the device heartbeat feedback information and that is to be returned to the cloud application client. A data structure indicated by the client heartbeat feedback information and a data structure indicated by the device heartbeat feedback information are consistent, and may both include a heartbeat signal parameter field. A heartbeat signal indicated by a heartbeat signal parameter field in the client heartbeat feedback information may be the same as a heartbeat signal indicated by a heartbeat signal parameter field in the device heartbeat feedback information. For example, if the operating system of the terminal device is a Windows system, the heartbeat signal in the device heartbeat feedback information sent by the cloud application client to the peripheral device may be an array [01 01 01 01]. The peripheral device generates the corresponding client heartbeat feedback information based on the heartbeat signal parameter field in the obtained device heartbeat feedback information, where a heartbeat signal of the client heartbeat feedback information is also the array [01 01 01 01].

For ease of description, both the device heartbeat feedback information and the client heartbeat feedback information may be referred to as heartbeat feedback information herein, or may be referred to as heartbeat packets. An interaction process of heartbeat feedback information is described herein with reference to a figure. FIG. 12 is a schematic flowchart of transmitting heartbeat feedback information according to an embodiment of this disclosure. As shown in FIG. 12, when the device heartbeat feedback information is generated, the cloud application client may further perform operation S901a shown in FIG. 12, to send, in the first communication manner through the terminal device, a device heartbeat feedback instruction corresponding to the device heartbeat feedback information to the peripheral device. In this way, after receiving the device heartbeat feedback information, the peripheral device may generate the client heartbeat feedback information based on the heartbeat signal indicated by the heartbeat signal parameter field in the device heartbeat feedback information, and then the peripheral device may perform operation S902a shown in FIG. 12, to return (that is, feed back) the client heartbeat feedback information to the cloud application client based on the first communication protocol through the terminal device.

When the first feedback instruction corresponding to the device heartbeat feedback information is received, a service mode of the peripheral device is a first service mode in which data transmission with the cloud application client is performed based on the first communication protocol. Then, this embodiment of this disclosure may further include: switching the service mode of the peripheral device from the first service mode to a second service mode if the peripheral device detects that a current time reaches a target time threshold and the first feedback instruction that corresponds to device heartbeat feedback information and that is delivered by the cloud application client through the first output interface is not received within the target time threshold.

The target time threshold may be a time that needs to be reached so that the peripheral device switches from the first service mode to the second service mode and in which no device heartbeat feedback instruction is received. For example, the target time threshold may be 2s. In this case, after the peripheral device receives the device heartbeat feedback instruction at a time t1 and performs a feedback operation based on the device heartbeat feedback instruction, when a current time reaches 2s and the device heartbeat feedback instruction delivered by the cloud application client by using the first output interface is not received within 2s, the peripheral device may switch from the first service mode to the second service mode. Based on this, after the cloud application client is closed, or when a manner of transmitting data by the cloud application client based on the first communication protocol fails, the service mode of the peripheral device may switch back to the second service mode in time. In this way, when the peripheral device is in the second service mode, communication between the peripheral device and the terminal device may continue to be implemented in the second communication manner, to ensure reliability of data transmission.

When the first service mode of the peripheral device is independent of the second service mode, if the peripheral device detects that the current time reaches the target time threshold and the device heartbeat feedback information delivered by the cloud application client is not received within the target time threshold, the peripheral device may switch the first service mode to the second service mode, to perform data transmission in the second communication manner. In some aspects, in another implementation, when the first service mode of the peripheral device is compatible with the second service mode, if the peripheral device detects that a current time reaches the target time threshold and the device heartbeat feedback information delivered by the cloud application client is not received within the target time threshold, the peripheral device may enable the second service mode compatible with the first service mode, to perform data transmission in the second communication manner.

The peripheral device includes at least one vibration motor, and a data structure corresponding to the device vibration feedback information obtained by the peripheral device includes at least the following parameter fields: one or more of a motor quantity parameter field, a vibration amplitude parameter field, a vibration time parameter field, a delay vibration time parameter field, and a vibration cycle parameter field; the motor quantity parameter field is used for indicating a quantity of vibration motors that perform a vibration operation; the vibration amplitude parameter field is used for indicating a vibration amplitude of a vibration motor during a vibration operation; the vibration time parameter field is used for indicating a vibration time for performing a vibration operation; the delay vibration time parameter field is used for indicating a delay vibration time for performing a vibration operation; and the vibration cycle parameter is used for indicating a quantity of vibration cycles for performing a vibration operation. In this case, a specific process in which the peripheral device performs the feedback operation indicated by the feedback data structure information in the first service data information may be described as follows: When the feedback data structure information includes the device vibration feedback information, the peripheral device may instruct, based on a parameter field in the device vibration feedback information, the at least one vibration motor to perform a vibration operation.

The vibration motor may be a linear vibration motor, or may be a rotor vibration motor. This is not limited herein. A vibration amplitude describes vibration intensity of the vibration motor during vibration. The vibration amplitude of the vibration motor may fall within a specific amplitude range. Vibration motors of different peripheral devices may have different amplitude ranges. This is not limited herein. The vibration time is used for indicating a vibration duration of a vibration operation. For example, if the vibration time is 2s, the vibration motor may continuously vibrate for two seconds. The delay vibration time is used for indicating how long the vibration operation needs to be delayed. The quantity of vibration cycles is used for indicating a quantity of cyclic vibrations per unit time, and is also equivalent to a vibration frequency. For example, the following is an example of a data structure indicated by device vibration feedback information:

ypedef struct GamepadVibrateOutputReport{
uint8_treportId;
uint8_tPID_GamePadSetEffectReportDcEnableActuators:4; //a quantity of motors
uint8_t :4;
uint8_tPID_GamePadSetEffectReportMagnitude[4]; //a vibration amplitude
uint8_tPID_GamePadSetEffectReportDuration; //a vibration time
uint8_tPID_GamePadSetEffectReportStartDelay; //a delay vibration time
uint8_tPID_GamePadSetEffectReportLoopCount; //a quantity of vibration cycles
}GamepadVibrateOutputReport;

For ease of description, the first feedback instruction corresponding to the device vibration feedback information is referred to as a device vibration feedback instruction herein. In other words, in this embodiment of this disclosure, the device vibration feedback information may be generated by the virtual cloud client on the cloud server. Then, the virtual cloud client may generate a device vibration feedback instruction based on the device vibration feedback information, and then send the device vibration feedback instruction corresponding to the device vibration feedback information to the cloud application client. Then, the cloud application client sends the device vibration feedback instruction to the peripheral device based on the first communication protocol. Each parameter field in the device vibration data structure information may indicate a vibration effect of a to-be-performed vibration operation. Then, the peripheral device may perform a corresponding vibration operation (also referred to as a vibration feedback operation) based on one or more vibration motors indicated by the parameter field in the device vibration feedback information. When receiving a vibration feedback instruction delivered by the cloud server, the cloud application client may determine the device vibration feedback instruction as the first feedback instruction. The device vibration feedback instruction herein may be generated when a virtual cloud client that corresponds to the cloud application client and that runs on the cloud server triggers a vibration feedback condition. For example, when supporting the first communication protocol, the virtual cloud client may intelligently determine whether the vibration feedback condition may be currently triggered. If yes, the device vibration feedback instruction may be generated once.

In some aspects, the device vibration feedback instruction may be generated by the virtual cloud client on the cloud server when it is detected that the vibration feedback condition needs to be triggered. For example, in a cloud game scenario, to enrich cloud game experience, the virtual cloud client may trigger the vibration feedback condition when detecting that a game object controlled by a service object is shot or hit by a bomb, to generate the device vibration feedback instruction.

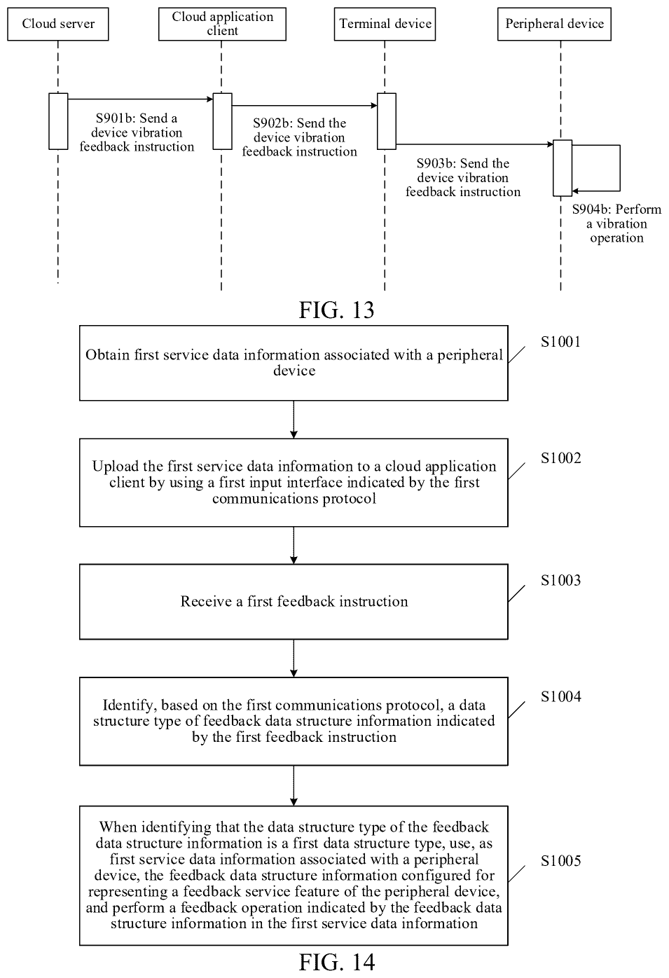

An interaction process of device vibration feedback information between ends is described herein with reference to a figure. FIG. 13 is a schematic flowchart of transmitting vibration feedback information according to an embodiment of this disclosure. As shown in FIG. 13, when detecting that a game object controlled by a service object is hit by a bomb, a virtual cloud client on a cloud server may trigger a vibration feedback condition, to generate a device vibration feedback instruction, and then may perform operation S901b shown in FIG. 13, that is, send the device vibration feedback instruction to the cloud application client. As shown in FIG. 13, the cloud application client may further perform operation S902b, to send the device vibration feedback instruction to the terminal device (for example, the USB driver in the terminal device) as the first feedback instruction based on the first communication protocol. Then, the terminal device (for example, the USB driver in the terminal device) may further perform operation S903b, to send the device vibration feedback instruction to the peripheral device as the first feedback instruction through the first output interface. In other words, in this embodiment of this disclosure, the cloud application client may directly send the device vibration feedback instruction to the peripheral device through the terminal device based on the first communication protocol, and then the peripheral device may parse the currently obtained device vibration feedback instruction, and then when performing operation S904b, perform a vibration operation based on the device vibration feedback information indicated by the device vibration feedback instruction.

The peripheral device stores at least one piece of vibration effect control information used for indicating a vibration effect, and the vibration effect control information includes at least one or more of the following: a quantity of vibration motors that perform a vibration operation, a vibration amplitude of a vibration motor during a vibration operation, a vibration time for performing a vibration operation, a delay vibration time for performing a vibration operation, and a quantity of vibration cycles for performing a vibration operation; each piece of vibration effect control information is associated with a corresponding vibration effect identifier, a data structure corresponding to the device vibration feedback information includes at least an effect identifier field, and the effect identifier field is used for indicating a vibration effect identifier corresponding to a to-be-performed vibration operation. In this case, a specific process in which the peripheral device performs the feedback operation indicated by the device vibration feedback information in the first service data information may be described as follows: When the feedback data structure information includes device vibration feedback information, the peripheral device queries vibration effect control information associated with a vibration effect identifier indicated by the feedback data structure information, and performs a vibration operation based on the queried vibration effect control information.

For example, the vibration effect control information stored in the peripheral device may include vibration effect control information whose vibration effect identifiers are 1, 2, 3, 4, and 5. If the feedback data structure information received by the peripheral device includes the device vibration feedback information, and a vibration effect identifier indicated by an effect identifier field in the device vibration feedback information is 4, the peripheral device may perform a vibration operation based on the vibration effect control information whose vibration effect identifier is 4.

As described above, the feedback service feature includes one or more of the following: a service feature that is used to feed back a device heartbeat and that corresponds to the device heartbeat feedback information, and a service feature that is used to control a device vibration and that corresponds to the device vibration feedback information. In this case, the peripheral device may further be configured to perform the following operations: The peripheral device may receive the device scanning instruction delivered by the cloud application client on the terminal device by using the first output interface. Further, the peripheral device may obtain, based on the device scanning instruction, first interface information supported by the peripheral device, and return the first interface information to the cloud application client by using the first input interface indicated by the first communication protocol; where the first interface information includes at least one or more of the following interface information: heartbeat feedback interface information corresponding to the device heartbeat feedback information, and vibration feedback interface information corresponding to the device vibration feedback information. Further, when receiving a device feature query instruction delivered by the cloud application client for the first interface information through the first output interface, the peripheral device may query, based on the device feature query instruction, a first service feature supported by the peripheral device, and return the first service feature to the cloud application client through the first input interface indicated by the first communication protocol, where the first service feature includes the feedback service feature.

The first interface information (that is, heartbeat feedback interface information) corresponding to the device heartbeat feedback information may be specifically a software interface whose interface name is HeartBeatOutputReport( ) in the data structure corresponding to the device heartbeat feedback information. The first interface information (that is, vibration feedback interface information) corresponding to the device vibration feedback information may be specifically a software interface whose interface name is Gamepad VibrateOutputReport( ) in the data structure corresponding to the device vibration feedback information. The first service feature may include an input service feature and a feedback service feature.

As described above, when the cloud application client starts the cloud application, the service mode of the peripheral device may be switched from the second service mode to the first service mode. Specifically, the peripheral device may receive a mode switching instruction delivered by the cloud application client based on the first communication protocol when a cloud application is started, and switch the service mode of the peripheral device from the second service mode to the first service mode based on the mode switching instruction, where the first service mode is used for instructing the peripheral device to perform data transmission with the cloud application client based on the first communication protocol.

When the cloud application client starts the cloud application, the cloud application client sends the device scanning instruction to the peripheral device based on the first communication protocol. In this way, when receiving the device scanning instruction, the peripheral device may switch the service mode of the peripheral device from the second service mode to the first service mode. When the first service mode of the peripheral device is independent of the second service mode, if the peripheral device receives the mode switching instruction or the device scanning instruction, the peripheral device may switch the second service mode to the first service mode. In some aspects, in another implementation, when the first service mode of the peripheral device is compatible with the second service mode, if the peripheral device receives the mode switching instruction or the device scanning instruction, the peripheral device may not enable the second service mode compatible with the first service mode and perform data transmission based on the first communication protocol.

Further, FIG. 14 is a schematic flowchart 3 of a data processing method according to an embodiment of this disclosure. The method may be performed by a peripheral device supporting a first communication protocol (as shown in 10c in FIG. 1). For example, the peripheral device may be a gamepad. The method may include at least the following operation S1001 to operation S1005.

S1001: Obtain first service data information associated with a peripheral device; the first service data information including input data structure information configured for representing an input service feature of the peripheral device, and the input data structure information including at least one or more of object operation data information, device attribute data information, and device battery strength data information.

S1002: Upload the first service data information to a cloud application client by using a first input interface indicated by the first communication protocol, so that the cloud application client transmits the first service data information to a virtual cloud client corresponding to the cloud application client, the virtual cloud client herein being run in a cloud server; the first service data information being configured to instruct the cloud server to identify a data structure type of the first service data information when the virtual cloud client supports the first communication protocol, and when identifying that the data structure type of the first service data information is a first data structure type, instruct the cloud server to parse the first service data information to obtain input data information indicated by the input data structure information, and instruct the cloud server to obtain media data information that corresponds to the input data information and that is to be returned to the cloud application client, and the cloud application client being configured to output the media data information corresponding to the input data information.

S1003: Receive a first feedback instruction; the first feedback instruction being delivered by a cloud application client by using a first output interface indicated by the first communication protocol.

In other words, in this embodiment of this disclosure, the peripheral device may receive the first feedback instruction delivered by the cloud application client by using the first output interface indicated by the first communication protocol. The first feedback instruction herein may include, but is not limited to, the device vibration feedback instruction and/or the device heartbeat feedback instruction.

S1004: Identify, based on the first communication protocol, a data structure type of feedback data structure information indicated by the first feedback instruction.

S1005: When identifying that the data structure type of the feedback data structure information is a first data structure type, use, as first service data information associated with the peripheral device, the feedback data structure information configured for representing a feedback service feature of the peripheral device, and perform a feedback operation indicated by the feedback data structure information in the first service data information; the feedback data structure information including at least one or more of device heartbeat feedback information and device vibration feedback information of the peripheral device.

Based on the foregoing description, the peripheral device may passively receive the feedback data structure information of the specific data structure carried in the first feedback instruction delivered by the cloud application client based on the first communication protocol, and then may use the received feedback data structure information as the first service data information, to perform a specific feedback operation. In addition, the peripheral device may also actively generate input data structure information (for example, one or more of the object operation data information, the device attribute data information, and the device battery strength data information) of a specific data structure, to use the generated input data structure information as the first service data information, so as to further upload the first service data information to the cloud application client based on the first communication protocol.

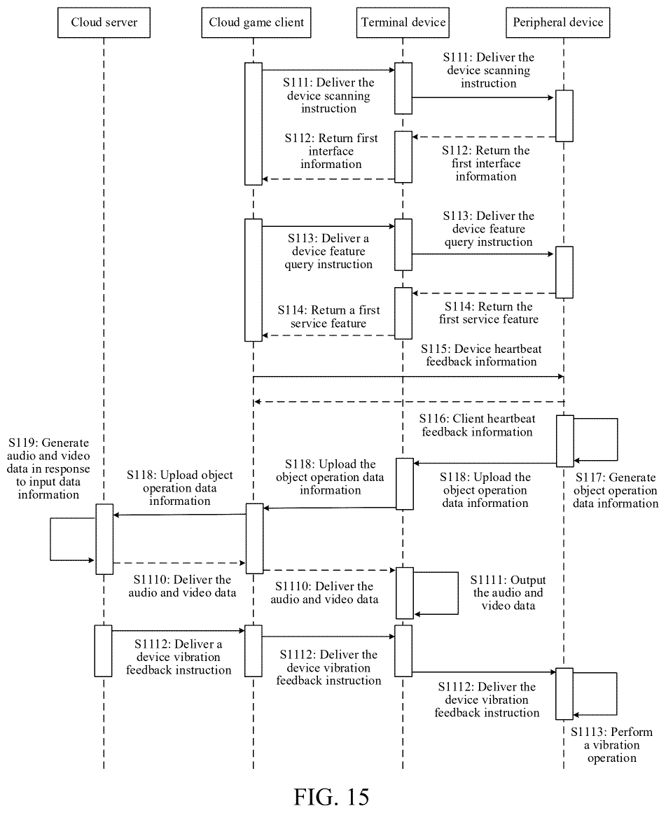

A process of exchanging data between the peripheral device and the cloud application client based on the first communication protocol is described herein by using an example. For ease of understanding, an example in which the cloud application client is a cloud game client is used herein. Further, FIG. 15 is a schematic flowchart of a data exchange process according to an embodiment of this disclosure. As shown in FIG. 15, when the cloud game client starts a cloud game, the cloud game client may deliver a device scanning instruction to the peripheral device through the terminal device (operation S111), and the peripheral device may query device interface information based on the device scanning instruction, and return queried first interface information to the cloud game client through the terminal device (operation S112). The cloud game client may deliver a device feature query instruction for the first interface information to the peripheral device (operation S113), and then the peripheral device queries a service feature of the peripheral device based on the device feature query instruction, where queried service features are collectively referred to as a first service feature, and then may return the first service feature to the cloud application client (such as the cloud game client) (operation S114).

As shown in FIG. 15, the cloud application client may generate device heartbeat feedback information at intervals (for example, 2s), and send the device heartbeat feedback information to the peripheral device based on the first output interface indicated by the first communication protocol (operation S115), and then the peripheral device may return client heartbeat feedback information to the cloud application client based on the received device heartbeat feedback information (operation S116), to ensure that data transmission may be performed between the peripheral device and the cloud application client based on the first communication protocol.

As shown in FIG. 15, in a running process of the cloud game, the peripheral device may further receive a trigger operation performed by a service object, then generate object operation data information based on input operation information corresponding to the trigger operation (operation S117), and then may upload the object operation data information to the cloud application client through the terminal device, to finally upload the object operation data information to a cloud server (operation S118). As shown in FIG. 15, when the cloud server parses the object operation data information to obtain input data information, the cloud server may generate audio and video data (herein, the audio and video data specifically includes video data and audio data) of a game image in response to the input data information, where the audio and video data herein is the media data information (operation S119). As shown in FIG. 15, the cloud server may send the generated audio and video data to the terminal device (operation S1110), so that the terminal device may output the audio and video data (operation S1111). For example, the output herein means that a game image of the cloud game may be displayed based on the video data, and game sound of the game image may be synchronously played based on the audio data.

In addition, as shown in FIG. 15, when the cloud server detects that a vibration feedback condition needs to be triggered, for example, when the virtual cloud client of the cloud server detects that a game object controlled by a service object is shot or hit by a bomb, the vibration feedback condition may be triggered, the cloud server generates a device vibration feedback instruction, and then sends the device vibration feedback instruction to the cloud game client, so that the cloud game client may send the device vibration feedback instruction to the peripheral device through the terminal device (operation S1112). Further, as shown in FIG. 15, the peripheral device may perform a vibration operation based on the device vibration feedback instruction (operation S1113). Data transmission in the foregoing data interaction process is performed based on the first communication protocol.

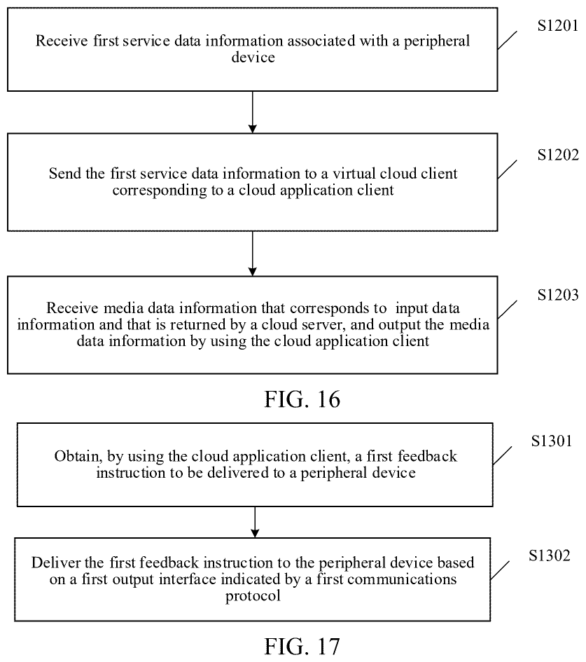

Further, FIG. 16 is a schematic flowchart 4 of a data processing method according to an embodiment of this disclosure. The method is performed by a terminal device, a cloud application client running in the terminal device supports a first communication protocol, and the terminal device herein may be the terminal device 10a in the embodiment corresponding to FIG. 1. The method may include at least the following operation S1201 to operation S1203.

S1201: Receive first service data information associated with a peripheral device; the first service data information herein being uploaded by a peripheral device by using a first input interface indicated by the first communication protocol, the first service data information including input data structure information configured for representing an input service feature of the peripheral device, and the input data structure information including at least one or more of object operation data information, device attribute data information, and device battery strength data information.

S1202: Send the first service data information to a virtual cloud client corresponding to the cloud application client; the virtual cloud client herein running in a cloud server, and the cloud server being configured to identify a data structure type of the first service data information when the running virtual cloud client supports the first communication protocol, and when identifying that the data structure type of the first service data information is a first data structure type, parse the first service data information to obtain input data information indicated by the input data structure information, and obtain media data information that corresponds to the input data information and that is to be returned to the cloud application client.

S1203: Receive the media data information that corresponds to the input data information and that is returned by the cloud server, and output the media data information by using the cloud application client.

The terminal device may deliver a mode switching instruction to the peripheral device based on the first communication protocol when starting a cloud application by using the cloud application client, so that the peripheral device switches a service mode of the peripheral device from a second service mode to a first service mode based on the mode switching instruction, where the first service mode is used for instructing the peripheral device to perform data transmission with the cloud application client based on the first communication protocol.

The cloud application started in the cloud application client includes a cloud game, the peripheral device includes a gamepad configured to control a game object in the cloud game, and the gamepad includes at least one or more operable components of a gamepad joystick, a gamepad key, a six-axis sensor, and a touchpad; a data structure corresponding to the object operation data information includes at least the following parameter fields: one or more of an axial parameter field of the gamepad, a key parameter field of the gamepad, a sensor parameter field of the gamepad, and a direction parameter field of the gamepad, the axial parameter field is used for indicating an operation value when the gamepad joystick is operated on each of N direction axes, N is a positive integer greater than or equal to 3, the key parameter field is used for indicating an operation key value of a key of the gamepad; the sensor parameter field is used for indicating a sensing value of the six-axis sensor on each of K coordinate axes, K is a positive integer greater than or equal to 6, and the K coordinate axes include an acceleration coordinate axis and an angular velocity coordinate axis; the direction parameter field is used for indicating an operation key value when the service object slides towards each of M directions on the touchpad, and M is a positive integer greater than or equal to 4. The object operation data information is generated, in response to a trigger operation performed by a service object on the peripheral device, by the peripheral device based on input operation information corresponding to the trigger operation.

The cloud application client running in the terminal device may deliver a device attribute query instruction to the peripheral device based on a first output interface indicated by the first communication protocol, so that the peripheral device queries a device attribute of the peripheral device based on the device attribute query instruction and generates the device attribute data information according to the queried device attribute. A data structure corresponding to the device attribute data information includes at least the following parameter fields: a manufacturer parameter field of the peripheral device, a device model parameter field of the peripheral device, a firmware parameter field of the peripheral device, and a sensor parameter field of the peripheral device; the manufacturer parameter field is used for indicating a manufacturer serial number of the peripheral device; the device model parameter field is used for indicating a device model of the peripheral device; the firmware parameter field is used for indicating a firmware building time of the peripheral device; and the sensor parameter field is used for indicating a measurement range and/or a sampling frequency of a six-axis sensor of the peripheral device.

A data structure corresponding to the device battery strength data information includes at least the following parameter field: a device battery strength parameter field, the device battery strength parameter field is used for indicating a battery strength value of a device battery strength of the peripheral device, and the device battery strength data information is generated, when detecting that a device battery strength of the peripheral device is lower than a battery strength threshold, by the peripheral device based on the detected device battery strength.

The cloud application client running on the terminal device may send a battery strength query instruction to the peripheral device based on the first output interface indicated by the first communication protocol, so that the peripheral device queries a device battery strength of the peripheral device based on the battery strength query instruction and generates the device battery strength data information based on the queried device battery strength. A data structure corresponding to the device battery strength data information includes at least the following parameter field: a device battery strength parameter field, and the device battery strength parameter field is used for indicating a battery strength value of a device battery strength of the peripheral device.

The input service feature includes one or more of the following: a service feature that corresponds to the object operation data information and that is used for obtaining the input operation information, a service feature that corresponds to the device attribute data information and that is used for obtaining the device attribute, and a service feature that corresponds to the device battery strength data information and that is used for obtaining the device battery strength. In this case, the terminal device can also be configured to perform the following operations. Specifically, the cloud application client running in the terminal device may further deliver a device scanning instruction to the peripheral device based on the first output interface indicated by the first communication protocol, so that the peripheral device obtains, based on the device scanning instruction, first interface information supported by the peripheral device; where the first interface information includes at least one or more of the following interface information: first object operation data interface information corresponding to the object operation data information, first attribute obtaining interface information corresponding to the device attribute data information, and first battery strength obtaining interface information corresponding to the device battery strength data information. Further, the cloud application client running in the terminal device may receive the first interface information returned by the peripheral device by using the first input interface, and send a device feature query instruction for the first interface information to the peripheral device by using the first output interface, so that the peripheral device queries, based on the device feature query instruction, a first service feature supported by the peripheral device, where the first service feature includes an input service feature. Further, the cloud application client running in the terminal device may receive the first service feature returned by the peripheral device by using the first input interface indicated by the first communication protocol.

Further, FIG. 17 is a schematic flowchart 5 of a data processing method according to an embodiment of this disclosure. The method is performed by a terminal device, and a cloud application client running in the terminal device herein supports a first communication protocol. The terminal device may be the terminal device 10a in the embodiment corresponding to FIG. 1. The method may include at least the following operations S1301 and S1302.

S1301: Obtain, by using the cloud application client, a first feedback instruction to be delivered to a peripheral device.

The first feedback instruction obtained by the cloud application client may include the device vibration feedback instruction and/or the device heartbeat feedback instruction. Further, when performing the following operation S1302, the terminal device may deliver the first feedback instruction to the peripheral device based on the first output interface indicated by the first communication protocol supported by the cloud application client.

S1302: Deliver the first feedback instruction to the peripheral device based on a first output interface indicated by the first communication protocol, so that the peripheral device identifies, based on the first communication protocol, a data structure type of feedback data structure information indicated by the first feedback instruction, and when identifying that the data structure type of the feedback data structure information is a first data structure type, uses, as first service data information associated with the peripheral device, the feedback data structure information configured for representing a feedback service feature of the peripheral device, and performs a feedback operation indicated by the feedback data structure information in the first service data information; the feedback data structure information including at least one or more of device heartbeat feedback information and device vibration feedback information of the peripheral device.

The terminal device may deliver a mode switching instruction to the peripheral device based on the first communication protocol when starting a cloud application by using the cloud application client, so that the peripheral device switches a service mode of the peripheral device from a second service mode to a first service mode based on the mode switching instruction, where the first service mode is used for instructing the peripheral device to perform data transmission with the cloud application client based on the first communication protocol.

When the cloud application client triggers a heartbeat feedback condition, the terminal device may generate, based on an operating system type of an operating system of the terminal device running cloud application client, a device heartbeat feedback instruction corresponding to the device heartbeat feedback information, and determine the device heartbeat feedback instruction as the first feedback instruction, so that the terminal device may subsequently obtain the first feedback instruction through the cloud application client when performing operation S1301. A data structure corresponding to the device heartbeat feedback information includes at least a heartbeat signal parameter field, the heartbeat signal parameter field is a heartbeat signal corresponding to the operating system type of the operating system of the terminal device, and different operating system types may correspond to different heartbeat signals. The operating system type of the operating system of the terminal device includes any one of the following: an operating system type applicable to a mobile phone terminal and an operating system type applicable to a computer terminal. Further, the terminal device may further receive client heartbeat feedback information. The client heartbeat feedback information is uploaded by the peripheral device by using a first input interface indicated by the first communication protocol. In other words, the terminal devices herein can receive the client heartbeat feedback information uploaded by the peripheral device by using the first input interface indicated by the first communication protocol, the client heartbeat feedback information is determined by the peripheral device based on the device heartbeat feedback information when the feedback data structure information indicated by the first feedback instruction includes the device heartbeat feedback information, and the client heartbeat feedback information includes at least the heartbeat signal parameter field.

The peripheral device includes at least one vibration motor. The terminal device may receive a device vibration feedback instruction sent by the cloud server, and determine the device vibration feedback instruction as the first feedback instruction. The device vibration feedback instruction herein is generated when a virtual cloud client that corresponds to the cloud application client and that runs on the cloud server triggers a vibration feedback condition. In other words, in this embodiment of this disclosure, the terminal device may receive the first feedback instruction sent by the cloud server on which the virtual cloud client corresponding to the cloud application client runs on the cloud. the device vibration feedback information in the first feedback instruction is used to instruct the peripheral device to perform a vibration operation based on an indication of the device vibration feedback information, a data structure corresponding to the device vibration feedback information includes at least the following parameter fields: one or more of a motor quantity parameter field, a vibration amplitude parameter field, a vibration time parameter field, a delay vibration time parameter field, and a vibration cycle parameter field; the motor quantity parameter field is used for indicating a quantity of vibration motors that perform a vibration operation; the vibration amplitude parameter field is used for indicating a vibration amplitude of a vibration motor during a vibration operation; the vibration time parameter field is used for indicating a vibration time for performing a vibration operation; the delay vibration time parameter field is used for indicating a delay vibration time for performing a vibration operation; and the vibration cycle parameter is used for indicating a quantity of vibration cycles for performing a vibration operation.

The peripheral device stores at least one piece of vibration effect control information used for indicating a vibration effect, and the vibration effect control information includes at least one or more of the following: a quantity of vibration motors that perform a vibration operation, a vibration amplitude of a vibration motor during a vibration operation, a vibration time for performing a vibration operation, a delay vibration time for performing a vibration operation, and a quantity of vibration cycles for performing a vibration operation; and each piece of vibration effect control information is associated with a corresponding vibration effect identifier. In this case, the terminal device may further receive a device vibration feedback instruction, and determine the device vibration feedback instruction as the first feedback instruction. The device vibration feedback instruction herein is generated when the virtual cloud client that corresponds to the cloud application client and that runs on the cloud server triggers a vibration feedback condition. In other words, in this embodiment of this disclosure, the terminal device may receive the first feedback instruction sent by the cloud server on which the virtual cloud client corresponding to the cloud application client runs on the cloud. A data structure corresponding to the device vibration feedback information indicated by the device vibration feedback instruction includes at least an effect identifier field, the effect identifier field is used for indicating a vibration effect identifier corresponding to a to-be-performed vibration operation, and the device vibration feedback information is configured for instructing the peripheral device to query vibration effect control information matching a vibration effect identifier indicated by the feedback data structure information, and perform a vibration operation based on the queried vibration effect control information.

The feedback service feature includes one or more of the following: a service feature that is used to feed back a device heartbeat and that corresponds to the device heartbeat feedback information, and a service feature that is used to control a device vibration and that corresponds to the device vibration feedback information. In this case, the cloud application client running in the terminal device may further deliver a device scanning instruction to the peripheral device based on the first output interface, so that the peripheral device obtains, based on the device scanning instruction, first interface information supported by the peripheral device; where the first interface information includes at least one or more of the following interface information: heartbeat feedback interface information corresponding to the device heartbeat feedback information, and vibration feedback interface information corresponding to the device vibration feedback information. Further, the cloud application client running in the terminal device further may receive the first interface information returned by the peripheral device by using the first input interface indicated by the first communication protocol, and send a device feature query instruction for the first interface information to the peripheral device by using the first output interface, so that the peripheral device queries, based on the device feature query instruction, a first service feature supported by the peripheral device, where the first service feature includes a feedback service feature. Further, the cloud application client running in the terminal device may further receive the first service feature returned by the peripheral device by using the first input interface indicated by the first communication protocol.

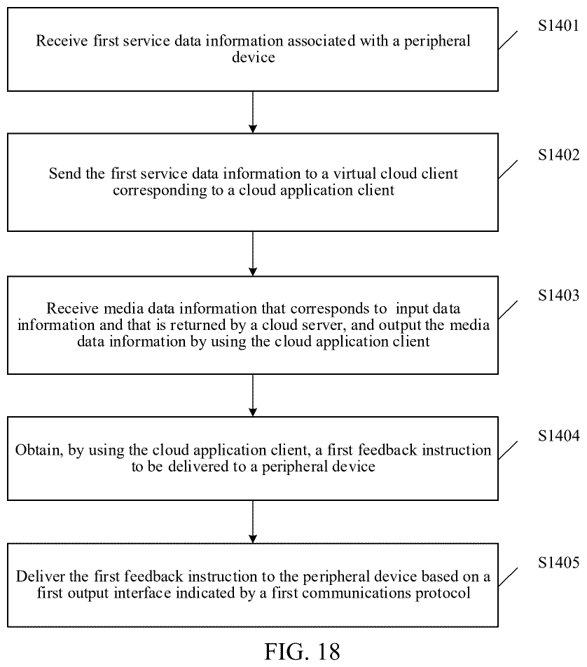

Further, FIG. 18 is a schematic flowchart 6 of a data processing method according to an embodiment of this disclosure. The method is performed by a terminal device, and a cloud application client running in the terminal device herein supports a first communication protocol. The terminal device may be the terminal device 10a in the embodiment corresponding to FIG. 1. The method may include at least the following operation S1401 to operation S1405.

S1401: Receive first service data information associated with a peripheral device; the first service data information being uploaded by the peripheral device by using a first input interface indicated by the first communication protocol, the first service data information including input data structure information configured for representing an input service feature of the peripheral device, and the input data structure information including at least one or more of object operation data information, device attribute data information, and device battery strength data information;

S1402: Send the first service data information to a virtual cloud client corresponding to the cloud application client; the virtual cloud client running in a cloud server, and the cloud server herein being configured to identify a data structure type of the first service data information when the running virtual cloud client supports the first communication protocol, and when identifying that the data structure type of the first service data information is a first data structure type, parse the first service data information to obtain input data information indicated by the input data structure information, and obtain media data information that corresponds to the input data information and that is to be returned to the cloud application client.

S1403: Receive the media data information that corresponds to the input data information and that is returned by the cloud server, and output the media data information by using the cloud application client.

S1404: Obtain, by using the cloud application client, a first feedback instruction to be delivered to a peripheral device.

S1405: Deliver the first feedback instruction to the peripheral device based on a first output interface indicated by the first communication protocol, so that the peripheral device identifies, based on the first communication protocol, a data structure type of feedback data structure information indicated by the first feedback instruction, and when identifying that the data structure type of the feedback data structure information is a first data structure type, uses, as first service data information associated with the peripheral device, the feedback data structure information configured for representing a feedback service feature of the peripheral device, and performs a feedback operation indicated by the feedback data structure information in the first service data information; the feedback data structure information including at least one or more of device heartbeat feedback information and device vibration feedback information of the peripheral device.

As can be seen, when the terminal device in this disclosure runs the cloud application client, the terminal device may rapidly receive, through the cloud application client, the first service data information uploaded by the peripheral device by using the first input interface indicated by the first communication protocol, and then may rapidly upload the first service data information to the virtual cloud client based on the first communication protocol supported by the cloud application client, so that when receiving the first service data information, the cloud server on which the virtual cloud client runs may rapidly parse the first service data information to obtain input data information based on the first communication protocol supported by the virtual cloud client. Then, in response to the input data information, media data information to be returned to the terminal device may be generated. In this way, when receiving the media data information returned by the cloud server, the terminal device may output the media data information by using the cloud application client on the terminal device. Because the media data information herein is the audio and video data, while displaying the application display image (for example, the game image) based on the video data in the audio and video data, the cloud application client on the terminal device may synchronously play, based on the audio data in the audio and video data, game sound corresponding to the application display image (for example, the game image). Therefore, in a scenario in which the cloud application is a cloud game, audio and images can be more accurately synchronized through data interaction among the peripheral device, the terminal device, and the cloud server. Besides, the peripheral device may be controlled based on the first feedback instruction to provide more diversified feedback operations, thereby providing more diversified game experience.

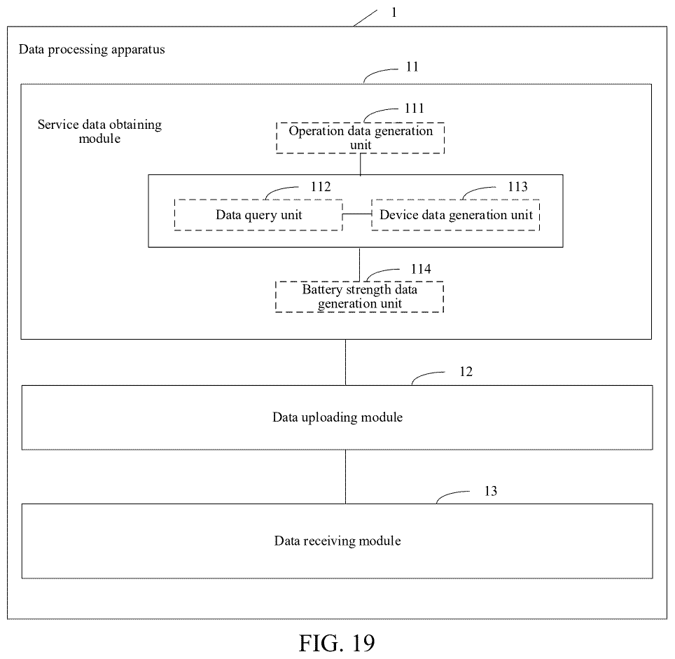

FIG. 19 is a schematic structural diagram of a data processing apparatus 1 according to an embodiment of this disclosure. As shown in FIG. 19, the data processing apparatus 1 may be configured to perform the corresponding operations in the data processing method provided in the embodiments of this disclosure. As shown in FIG. 19, the data processing apparatus 1 may include: a service data obtaining module 11 and a data uploading module 12.

The service data obtaining module 11 is configured to obtain first service data information associated with the peripheral device; the first service data information including input data structure information configured for representing an input service feature of the peripheral device, and the input data structure information including at least one or more of object operation data information, device attribute data information, and device battery strength data information.

The data uploading module 12 is configured to upload the first service data information to a cloud application client by using a first input interface indicated by the first communication protocol, so that the cloud application client transmits the first service data information to a virtual cloud client corresponding to the cloud application client; the virtual cloud client running in a cloud server, the first service data information being configured to instruct the cloud server to identify a data structure type of the first service data information when the virtual cloud client supports the first communication protocol, and when identifying that the data structure type of the first service data information is a first data structure type, instruct the cloud server to parse the first service data information to obtain input data information indicated by the input data structure information, and instruct the cloud server to obtain media data information that corresponds to the input data information and that is to be returned to the cloud application client, and the cloud application client being configured to output the media data information corresponding to the input data information.

The data processing apparatus 1 may further include a data receiving module 13.

The data receiving module 13 is configured to receive a mode switching instruction, where the mode switching instruction is delivered by the cloud application client based on a first communication protocol when the cloud application client starts a cloud application.

The data receiving module 13 is further configured to switch a service mode of the peripheral device from a second service mode to a first service mode based on the mode switching instruction, where the first service mode is used for instructing the peripheral device to perform data transmission with the cloud application client based on the first communication protocol.

The cloud application started in the cloud application client includes a cloud game, the peripheral device includes a gamepad configured to control a game object in the cloud game, and the gamepad includes at least one or more operable components of a gamepad joystick, a gamepad key, a six-axis sensor, and a touchpad.

The service data obtaining module 11 may include: an operation data generation unit 111.

The operation data generation unit 111 is configured to generate, in response to a trigger operation performed by a service object on the peripheral device, the object operation data information based on input operation information corresponding to the trigger operation, and determine the object operation data information as the first service data information, where a data structure corresponding to the object operation data information includes at least the following parameter fields: one or more of an axial parameter field of the gamepad, a key parameter field of the gamepad, a sensor parameter field of the gamepad, and a direction parameter field of the gamepad, the axial parameter field is used for indicating an operation value when the gamepad joystick is operated on each of N direction axes, N is a positive integer greater than or equal to 3, the key parameter field is used for indicating an operation key value of a key of the gamepad; the sensor parameter field is used for indicating a sensing value of the six-axis sensor on each of K coordinate axes, K is a positive integer greater than or equal to 6, and the K coordinate axes include an acceleration coordinate axis and an angular velocity coordinate axis; the direction parameter field is used for indicating an operation key value when the service object slides towards each of M directions on the touchpad, and M is a positive integer greater than or equal to 4.

The service data obtaining module 11 may include: a data query unit 112 and a device data generation unit 113.

The data query unit 112 is configured to query a device attribute of the peripheral device based on a device attribute query instruction when receiving the device attribute query instruction; where the device attribute query instruction is delivered by the cloud application client by using a first output interface indicated by the first communication protocol.

The device data generation unit 113 is configured to generate the device attribute data information according to the queried device attribute, and determine the device attribute data information as the first service data information, where a data structure corresponding to the device attribute data information includes at least the following parameter fields: a manufacturer parameter field of the peripheral device, a device model parameter field of the peripheral device, a firmware parameter field of the peripheral device, a sensor parameter field of the peripheral device, and a service feature parameter field of the peripheral device; the manufacturer parameter field is used for indicating a manufacturer serial number of the peripheral device; the device model parameter field is used for indicating a device model of the peripheral device; the firmware parameter field is used for indicating a firmware building time of the peripheral device; the sensor parameter field is used for indicating a measurement range and/or a sampling frequency of a six-axis sensor of the peripheral device; and the service feature parameter field is used for indicating a service feature supported by the peripheral device.

The service data obtaining module 11 may include: a battery strength data generation unit 114.

The battery strength data generation unit 114 is configured to generate, when detecting that a device battery strength of the peripheral device decreases to a battery strength threshold, the device battery strength data information based on the detected device battery strength, and determine the device battery strength data information as the first service data information; where a data structure corresponding to the device battery strength data information includes at least the following parameter field: a device battery strength parameter field, and the device battery strength parameter field is used for indicating a battery strength value of a device battery strength of the peripheral device.

The battery strength data generation unit 114 is further configured to query a device battery strength of the peripheral device based on a battery strength query instruction when receiving the battery strength query instruction; where the battery strength query instruction is delivered by the cloud application client by using a first output interface indicated by the first communication protocol; and

The battery strength data generation unit 114 is further configured to generate the device battery strength data information based on the queried device battery strength, and determine the device battery strength data information as the first service data information; where a data structure corresponding to the device battery strength data information includes at least the following parameter field: a device battery strength parameter field, and the device battery strength parameter field is used for indicating a battery strength value of a device battery strength of the peripheral device.

The input service feature includes one or more of the following: a service feature that corresponds to the object operation data information and that is used for obtaining the input operation information, a service feature that corresponds to the device attribute data information and that is used for obtaining the device attribute, and a service feature that corresponds to the device battery strength data information and that is used for obtaining the device battery strength.

The data receiving module 13 is further configured to receive a device scanning instruction. The device scanning instruction is delivered, by using the first output interface indicated by the first communication protocol, by the cloud application client running in a terminal device.

The data uploading module 12 is configured to obtain, based on the device scanning instruction, first interface information supported by the peripheral device, and return the first interface information to the cloud application client by using the first input interface indicated by the first communication protocol; where the first interface information includes at least one or more of the following interface information: first object operation data interface information corresponding to the object operation data information, first attribute obtaining interface information corresponding to the device attribute data information, and first battery strength obtaining interface information corresponding to the device battery strength data information.

The data uploading module 12 is further configured to: when receiving a device feature query instruction delivered by the cloud application client for the first interface information through the first output interface, query, based on the device feature query instruction, a first service feature supported by the peripheral device, and return the first service feature to the cloud application client through the first input interface indicated by the first communication protocol, where the first service feature includes the input service feature.

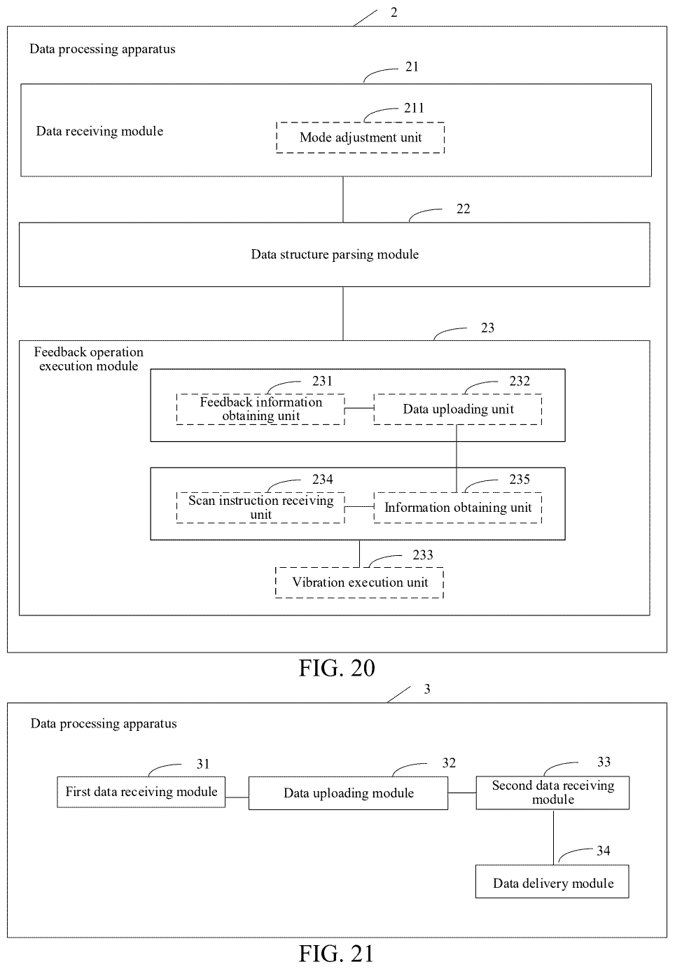

FIG. 20 is a schematic structural diagram of a data processing apparatus 2 according to an embodiment of this disclosure. As shown in FIG. 20, the data processing apparatus 2 may be configured to perform the corresponding operations in the data processing method provided in the embodiments of this disclosure. As shown in FIG. 20, the data processing apparatus 2 may include: a data receiving module 21, a data structure parsing module 22, and a feedback operation execution module 23.

The data receiving module 21 is configured to receive a first feedback instruction; the first feedback instruction being delivered by a cloud application client by using a first output interface indicated by the first communication protocol.

The data structure parsing module 22 is configured to identify, based on the first communication protocol, a data structure type of feedback data structure information indicated by the first feedback instruction.

The feedback operation execution module 23 is configured to: when it is identified that the data structure type of the feedback data structure information is a first data structure type, use, as first service data information associated with the peripheral device, the feedback data structure information configured for representing a feedback service feature of the peripheral device, and perform a feedback operation indicated by the feedback data structure information in the first service data information; the feedback data structure information including at least one or more of device heartbeat feedback information and device vibration feedback information of the peripheral device.

The data receiving module 21 includes: a mode adjustment unit 211.

The mode adjustment unit 211 is configured to receive a mode switching instruction; where the mode switching instruction is delivered by the cloud application client based on the first communication protocol when the cloud application client starts a cloud application.

The mode adjustment unit 211 is further configured to switch a service mode of the peripheral device from a second service mode to a first service mode based on the mode switching instruction, where the first service mode is used for instructing the peripheral device to perform data transmission with the cloud application client based on the first communication protocol.

The first feedback instruction corresponding to the device heartbeat feedback information is generated, based on an operating system type of an operating system of the terminal device running the cloud application client, by the application client when a heartbeat feedback condition is triggered; a data structure corresponding to the device heartbeat feedback information includes at least a heartbeat signal parameter field, and the heartbeat signal parameter field is a heartbeat signal corresponding to the operating system type of the operating system of the terminal device.

The feedback operation execution module 23 includes: a feedback information obtaining unit 231 and a data uploading unit 232.

The feedback information obtaining unit 231 is configured to obtain, when the feedback data structure information includes the device heartbeat feedback information, client heartbeat feedback information corresponding to the device heartbeat feedback information, where the client heartbeat feedback information belongs to the first service data information, and the client heartbeat feedback information includes at least the heartbeat signal parameter field.

The data uploading unit 232 is configured to upload the client heartbeat feedback information to the cloud application client by using a first input interface indicated by the first communication protocol.

When the first feedback instruction corresponding to the device heartbeat feedback information is received, a service mode of the peripheral device is a first service mode in which data transmission with the cloud application client is performed based on the first communication protocol.

The mode adjustment unit 211 is further configured to switch the service mode of the peripheral device from the first service mode to a second service mode if detecting that a current time reaches a target time threshold and the first feedback instruction that corresponds to the device heartbeat feedback information and that is delivered by the cloud application client through the first output interface is not received within the target time threshold.

The peripheral device includes at least one vibration motor, and a data structure corresponding to the device vibration feedback information includes at least the following parameter fields: one or more of a motor quantity parameter field, a vibration amplitude parameter field, a vibration time parameter field, a delay vibration time parameter field, and a vibration cycle parameter field; the motor quantity parameter field is used for indicating a quantity of vibration motors that perform a vibration operation; the vibration amplitude parameter field is used for indicating a vibration amplitude of a vibration motor during a vibration operation; the vibration time parameter field is used for indicating a vibration time for performing a vibration operation; the delay vibration time parameter field is used for indicating a delay vibration time for performing a vibration operation; and the vibration cycle parameter is used for indicating a quantity of vibration cycles for performing a vibration operation.

The feedback operation execution module 23 includes: a vibration execution unit 233.

The vibration execution unit 233 is configured to: when the feedback data structure information includes the device vibration feedback information, instruct, based on a parameter field in the device vibration feedback information, the at least one vibration motor to perform a vibration operation.

The peripheral device stores at least one piece of vibration effect control information used for indicating a vibration effect, and the vibration effect control information includes at least one or more of the following: a quantity of vibration motors that perform a vibration operation, a vibration amplitude of a vibration motor during a vibration operation, a vibration time for performing a vibration operation, a delay vibration time for performing a vibration operation, and a quantity of vibration cycles for performing a vibration operation; each piece of vibration effect control information is associated with a corresponding vibration effect identifier, a data structure corresponding to the device vibration feedback information includes at least an effect identifier field, and the effect identifier field is used for indicating a vibration effect identifier corresponding to a to-be-performed vibration operation.

The vibration execution unit 233 is further configured to: when the feedback data structure information includes the device vibration feedback information, query vibration effect control information associated with a vibration effect identifier indicated by the feedback data structure information, and perform a vibration operation based on the queried vibration effect control information.

The feedback service feature includes one or more of the following: a service feature that is used to feed back a device heartbeat and that corresponds to the device heartbeat feedback information, and a service feature that is used to control a device vibration and that corresponds to the device vibration feedback information.

The data feedback operation execution module 23 includes: a scanning instruction receiving unit 234, an information obtaining unit 235, and a data uploading unit 232.

The scanning instruction receiving unit 234 is further configured to receive a device scanning instruction. The device scanning instruction is delivered by using the first output interface by the cloud application client running in a terminal device.

The information obtaining unit 235 is configured to obtain, based on the device scanning instruction, first interface information supported by the peripheral device, and return the first interface information to the cloud application client by using the first input interface indicated by the first communication protocol; where the first interface information includes at least one or more of the following interface information: heartbeat feedback interface information corresponding to the device heartbeat feedback information, and vibration feedback interface information corresponding to the device vibration feedback information.

The data uploading unit 232 is configured to: when receiving a device feature query instruction delivered by the cloud application client for the first interface information through the first output interface, query, based on the device feature query instruction, a first service feature supported by the peripheral device, and return the first service feature to the cloud application client through the first input interface indicated by the first communication protocol, where the first service feature includes a feedback service feature.

FIG. 21 is a schematic structural diagram of a data processing apparatus 3 according to an embodiment of this disclosure. As shown in FIG. 21, the data processing apparatus 3 may be configured to perform the corresponding operations in the data processing method provided in the embodiments of this disclosure. As shown in FIG. 21, the data processing apparatus 3 may include: a first data receiving module 31, a data uploading module 32, and a second data receiving module 33.

The first data receiving module 31 is configured to receive first service data information associated with a peripheral device; the first service data information being uploaded by the peripheral device by using a first input interface indicated by the first communication protocol, the first service data information including input data structure information configured for representing an input service feature of the peripheral device, and the input data structure information including at least one or more of object operation data information, device attribute data information, and device battery strength data information.

The data uploading module 32 is configured to transmit the first service data information to a virtual cloud client corresponding to the cloud application client; the virtual cloud client running in a cloud server, and the cloud server being configured to identify a data structure type of the first service data information when the virtual cloud client supports the first communication protocol, and when identifying that the data structure type of the first service data information is a first data structure type, parse the first service data information to obtain input data information indicated by the input data structure information, and obtain media data information that corresponds to the input data information and that is to be returned to the cloud application client.

The second data receiving module 33 is configured to receive the media data information that corresponds to the input data information and that is returned by the cloud server, and output the media data information by using the cloud application client.

The data processing apparatus 3 further includes a data delivery module 34.

The data delivery module 34 is configured to deliver a mode switching instruction to the peripheral device based on the first communication protocol when starting a cloud application by using the cloud application client, so that the peripheral device switches a service mode of the peripheral device from a second service mode to a first service mode based on the mode switching instruction, where the first service mode is used for instructing the peripheral device to perform data transmission with the cloud application client based on the first communication protocol.

The cloud application started in the cloud application client includes a cloud game, the peripheral device includes a gamepad configured to control a game object in the cloud game, and the gamepad includes at least one or more operable components of a gamepad joystick, a gamepad key, a six-axis sensor, and a touchpad; a data structure corresponding to the object operation data information includes at least the following parameter fields: one or more of an axial parameter field of the gamepad, a key parameter field of the gamepad, a sensor parameter field of the gamepad, and a direction parameter field of the gamepad, the axial parameter field is used for indicating an operation value when the gamepad joystick is operated on each of N direction axes, N is a positive integer greater than or equal to 3, the key parameter field is used for indicating an operation key value of a key of the gamepad; the sensor parameter field is used for indicating a sensing value of the six-axis sensor on each of K coordinate axes, K is a positive integer greater than or equal to 6, and the K coordinate axes include an acceleration coordinate axis and an angular velocity coordinate axis; The direction parameter field is used for indicating an operation key value when the service object slides towards each of M directions on the touchpad, and M is a positive integer greater than or equal to 4. The object operation data information is generated, in response to a trigger operation performed by a service object on the peripheral device, by the peripheral device based on input operation information corresponding to the trigger operation.

The data delivery module 34 is further configured to deliver a device attribute query instruction to the peripheral device based on a first output interface indicated by the first communication protocol, so that the peripheral device queries a device attribute of the peripheral device based on the device attribute query instruction and generates the device attribute data information according to the queried device attribute; where a data structure corresponding to the device attribute data information includes at least the following parameter fields: a manufacturer parameter field of the peripheral device, a device model parameter field of the peripheral device, a firmware parameter field of the peripheral device, and a sensor parameter field of the peripheral device; the manufacturer parameter field is used for indicating a manufacturer serial number of the peripheral device; the device model parameter field is used for indicating a device model of the peripheral device; the firmware parameter field is used for indicating a firmware building time of the peripheral device; and the sensor parameter field is used for indicating a measurement range and/or a sampling frequency of a six-axis sensor of the peripheral device.

A data structure corresponding to the device battery strength data information includes at least the following parameter field: a device battery strength parameter field, the device battery strength parameter field is used for indicating a battery strength value of a device battery strength of the peripheral device, and the device battery strength data information is generated, when detecting that a device battery strength of the peripheral device is lower than a battery strength threshold, by the peripheral device based on the detected device battery strength.

The data delivery module 34 is further configured to send a battery strength query instruction to the peripheral device based on a first output interface indicated by the first communication protocol, so that the peripheral device queries a device battery strength of the peripheral device based on the battery strength query instruction and generates the device battery strength data information based on the queried device battery strength; where a data structure corresponding to the device battery strength data information includes at least the following parameter field: a device battery strength parameter field, and the device battery strength parameter field is used for indicating a battery strength value of a device battery strength of the peripheral device.

The input service feature includes one or more of the following: a service feature that corresponds to the object operation data information and that is used for obtaining the input operation information, a service feature that corresponds to the device attribute data information and that is used for obtaining the device attribute, and a service feature that corresponds to the device battery strength data information and that is used for obtaining the device battery strength.

The data delivery module 34 is further configured to deliver a device scanning instruction to the peripheral device based on the first output interface indicated by the first communication protocol, so that the peripheral device obtains, based on the device scanning instruction, first interface information supported by the peripheral device; where the first interface information includes at least one or more of the following interface information: first object operation data interface information corresponding to the object operation data information, first attribute obtaining interface information corresponding to the device attribute data information, and first battery strength obtaining interface information corresponding to the device battery strength data information.

The data delivery module 34 is further configured to receive the first interface information returned by the peripheral device by using the first input interface, and send a device feature query instruction for the first interface information to the peripheral device by using the first output interface, so that the peripheral device queries, based on the device feature query instruction, a first service feature supported by the peripheral device, where the first service feature includes an input service feature.

The first data receiving module 31 is further configured to receive the first service feature returned by the peripheral device by using the first input interface indicated by the first communication protocol.

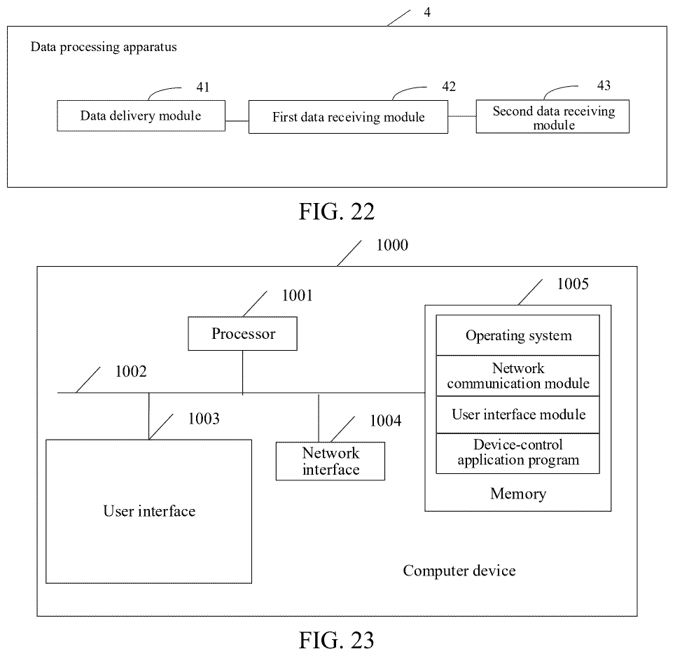

FIG. 22 is a schematic structural diagram of a data processing apparatus 4 according to an embodiment of this disclosure. As shown in FIG. 22, the data processing apparatus 4 may be configured to perform the corresponding operations in the data processing method provided in the embodiments of this disclosure. As shown in FIG. 22, the data processing apparatus 4 may include: a data delivery module 41.

The data deliver module 41 is configured to obtain, by using the cloud application client, a first feedback instruction to be delivered to a peripheral device.

The data deliver module 41 is further configured to deliver the first feedback instruction to the peripheral device based on a first output interface indicated by the first communication protocol, so that the peripheral device identifies, based on the first communication protocol, a data structure type of feedback data structure information indicated by the first feedback instruction, and when identifying that the data structure type of the feedback data structure information is a first data structure type, uses, as first service data information associated with the peripheral device, the feedback data structure information configured for representing a feedback service feature of the peripheral device, and performs a feedback operation indicated by the feedback data structure information in the first service data information; the feedback data structure information including at least one or more of device heartbeat feedback information and device vibration feedback information of the peripheral device.

The data delivery module 41 is further configured to deliver a mode switching instruction to the peripheral device based on the first communication protocol when starting a cloud application by using the cloud application client, so that the peripheral device switches a service mode of the peripheral device from a second service mode to a first service mode based on the mode switching instruction, where the first service mode is used for instructing the peripheral device to perform data transmission with the cloud application client based on the first communication protocol.

The data processing apparatus 4 includes: a first data receiving module 42.

The data delivery module 41 is further configured to: when the application client triggers a heartbeat feedback condition, generate, based on an operating system type of an operating system of the terminal device running the cloud application client, the first feedback instruction corresponding to the device heartbeat feedback information; where a data structure corresponding to the device heartbeat feedback information includes at least a heartbeat signal parameter field, the heartbeat signal parameter field is a heartbeat signal corresponding to the operating system type of the operating system of the terminal device, and different operating system types are associated with corresponding heartbeat signals.

The first data receiving module 42 is configured to receive the client heartbeat feedback information; where the client heartbeat feedback information is uploaded by the peripheral device by using a first input interface indicated by the first communication protocol, the client heartbeat feedback information is determined by the peripheral device based on the device heartbeat feedback information when the peripheral device identifies that the feedback data structure information indicated by the first feedback instruction includes the device heartbeat feedback information, and the client heartbeat feedback information includes at least the heartbeat signal parameter field.

The peripheral device includes at least one vibration motor.

The data processing apparatus 4 further includes: a second data receiving module 43.

The second data receiving module 43 is configured to receive a device vibration feedback instruction sent by a cloud server, and determine the device vibration feedback instruction as the first feedback instruction, where the device vibration feedback instruction is generated when a virtual cloud client that corresponds to the cloud application client and that runs on the cloud server triggers a vibration feedback condition, the device vibration feedback information in the first feedback instruction is used to instruct the peripheral device to perform a vibration operation based on an indication of the device vibration feedback information, a data structure corresponding to the device vibration feedback information includes at least the following parameter fields: one or more of a motor quantity parameter field, a vibration amplitude parameter field, a vibration time parameter field, a delay vibration time parameter field, and a vibration cycle parameter field; the motor quantity parameter field is used for indicating a quantity of vibration motors that perform a vibration operation; the vibration amplitude parameter field is used for indicating a vibration amplitude of a vibration motor during a vibration operation; the vibration time parameter field is used for indicating a vibration time for performing a vibration operation; the delay vibration time parameter field is used for indicating a delay vibration time for performing a vibration operation; and the vibration cycle parameter is used for indicating a quantity of vibration cycles for performing a vibration operation.

The peripheral device stores at least one piece of vibration effect control information used for indicating a vibration effect, and the vibration effect control information includes at least one or more of the following: a quantity of vibration motors that perform a vibration operation, a vibration amplitude of a vibration motor during a vibration operation, a vibration time for performing a vibration operation, a delay vibration time for performing a vibration operation, and a quantity of vibration cycles for performing a vibration operation; each piece of vibration effect control information is associated with a corresponding vibration effect identifier.

The second data receiving module 43 is further configured to receive a device vibration feedback instruction, and determine the device vibration feedback instruction as the first feedback instruction; where the device vibration feedback instruction is generated when a virtual cloud client that corresponds to the cloud application client and that runs on the cloud server triggers a vibration feedback condition, a data structure corresponding to the device vibration feedback information indicated by the device vibration feedback instruction includes at least an effect identifier field, the effect identifier field is used for indicating a vibration effect identifier corresponding to a to-be-performed vibration operation, and the device vibration feedback information is configured for instructing the peripheral device to query vibration effect control information matching a vibration effect identifier indicated by the feedback data structure information, and perform a vibration operation based on the queried vibration effect control information.

The feedback service feature includes one or more of the following: a service feature that is used to feed back a device heartbeat and that corresponds to the device heartbeat feedback information, and a service feature that is used to control a device vibration and that corresponds to the device vibration feedback information.

The data delivery module 41 is configured to deliver a device scanning instruction to the peripheral device through the cloud application client based on the first output interface, so that the peripheral device obtains, based on the device scanning instruction, first interface information supported by the peripheral device; where the first interface information includes at least one or more of the following interface information: heartbeat feedback interface information corresponding to the device heartbeat feedback information, and vibration feedback interface information corresponding to the device vibration feedback information.

The first data receiving module 42 is further configured to receive the first interface information returned by the peripheral device by using the first input interface indicated by the first communication protocol, and send a device feature query instruction for the first interface information to the peripheral device by using the first output interface, so that the peripheral device queries, based on the device feature query instruction, a first service feature supported by the peripheral device, where the first service feature includes a feedback service feature.

The first data receiving module 42 is further configured to receive the first service feature returned by the peripheral device by using the first input interface indicated by the first communication protocol.

FIG. 23 is a schematic structural diagram of a computer device according to an embodiment of this disclosure. As shown in FIG. 23, the computer device 1000 may include: a processor (an example of processing circuitry) 1001, a network interface 1004, and a memory 1005, and in addition, the computer device 1000 may further include: a user interface 1003 and at least one communication bus 1002. The communication bus 1002 is configured to implement connection and communication between these components. The user interface 1003 may include a display, a keyboard, and in some embodiments, the user interface 1003 may further include a standard wired interface and a standard wireless interface. The network interface 1004 may include a standard wired interface and wireless interface (for example, a WiFi interface) in some embodiments. The memory 1005 may be a high-speed RAM memory, or may be a non-volatile memory, for example, at least one magnetic disk memory. In some embodiments, the memory 1005 may be at least one storage apparatus that is located far away from the processor 1001. As shown in FIG. 23, the memory 1005 used as a computer-readable storage medium may include an operating system, a network communications module, a user interface module, and a device-control application program.

In the computer device 1000 shown in FIG. 23, the network interface 1004 may provide a network communication function. The user interface 1003 is mainly configured to provide an input interface for a user. The processor 1001 may be configured to call the device-control application program stored in the memory 1005 to implement the data processing method described in any one of the foregoing corresponding embodiments. Details are not described herein again. In addition, the description of beneficial effects of the same method are not described herein again.

In addition, an embodiment of this disclosure further provides a computer-readable storage medium, where the computer-readable storage medium stores a computer program executed by the foregoing data processing apparatus 1, the foregoing data processing apparatus 2, the foregoing data processing apparatus 3, and the foregoing data processing apparatus 4, and the computer program includes program instructions. When a processor executes the program instructions, the data processing method described in any one of the foregoing corresponding embodiments can be implemented. Therefore, details are not described herein again. In addition, the description of beneficial effects of the same method are not described herein again. For technical details that are not disclosed in the computer-readable storage medium embodiments of this disclosure, refer to the descriptions of the method embodiments of this disclosure.

The computer-readable storage medium may be the data processing apparatus in any one of the above embodiments or an internal storage unit of the computer device, such as a hard disk or a memory of the computer device. The computer-readable storage medium may also be an external storage device of the computer device, such as a plug-in hard disk equipped on the computer device, a smart media card (SMC), a secure digital (SD) card, a flash card, or the like. Further, the computer-readable storage medium may also include both the internal storage unit and the external storage device of the computer device. The computer-readable storage medium is configured to store the computer program and other programs and data required by the computer device. The computer-readable storage medium can also be configured to temporarily store data that has been outputted or will be outputted.

In addition, an embodiment of this disclosure further provides a computer program product or a computer program, the computer program product or the computer program including computer instructions, the computer instructions being stored in a computer-readable storage medium. A processor of a computer device reads the computer instructions from the computer-readable storage medium, and executes the computer instructions, to cause the computer device to perform the method described in any one of the foregoing corresponding embodiments. In addition, the description of beneficial effects of the same method are not described herein again. For technical details that are not disclosed in the computer program product or the computer program embodiments of this disclosure, refer to the descriptions of the method embodiments of this disclosure.

In the specification and claims and the accompanying drawings of the embodiments of this disclosure, the terms such as “first” and “second” are used to distinguish between different objects, but are not used to describe a particular sequence of the objects. In addition, the term “include” and any variant thereof are intended to cover a non-exclusive inclusion. For example, a process, a method, an apparatus, a product, or a device that includes a series of operations or units is not limited to the listed operations or modules; and instead, in some embodiments, further includes an operation or a module that is not listed, or in some embodiments, further includes another operation or unit that is intrinsic to the process, method, apparatus, product, or device.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A person of ordinary skill in the art may be aware that, in combination with the examples described in the embodiments disclosed in this specification, units and algorithm operations may be implemented by electronic hardware, computer software, or a combination thereof. To clearly describe the interchangeability between the hardware and the software, the foregoing has generally described compositions and operations of each example according to functions. Whether the functions are executed in a mode of hardware or software depends on particular applications and design constraint conditions of the technical solutions. A person skilled in the art can use different methods to implement the described functions for each particular application, but the implementation does not go beyond the scope of this disclosure.

What is disclosed above is merely examples of embodiments of this disclosure, and certainly is not intended to limit the scope of the claims of this disclosure. Therefore, equivalent variations made in accordance with the claims of this disclosure shall fall within the scope of this disclosure.

What is claimed is:

1. A method of data processing, comprising:
obtaining, by a peripheral device configured to support a first communication protocol, first service data information associated with the peripheral device, the first service data information comprising input data structure information that represents an input service feature of the peripheral device, and the input data structure information comprising at least one of object operation data information, device attribute data information, and device battery strength data information; and
uploading, by using a first input interface of the peripheral device configured according to the first communication protocol, the first service data information to a cloud application client running on a terminal device, the cloud application client transmitting the first service data information to a virtual cloud client running in a cloud server, the virtual cloud client being configured to support the first communication protocol and to cause the cloud server to parse the first service data information according to the first communication protocol to obtain input data information of the input service feature according to the input data structure information and to obtain media data information to be returned to the cloud application client as a response to the input data information, and the cloud application client being configured to output the media data information as the response to the input data information.

2. The method according to claim 1, further comprising:
receiving, by the peripheral device, a mode switching instruction from the cloud application client based on the first communication protocol when the cloud application client starts a cloud application; and
switching the peripheral device from a second service mode to a first service mode based on the mode switching instruction, the peripheral device in the first service mode being configured to perform data transmission with the cloud application client based on the first communication protocol, the peripheral device in the second service mode being configured to use a different communication protocol from the first communication protocol for the data transmission with the cloud application client.

3. The method according to claim 1, wherein:
the cloud application client has started one or more cloud applications including a cloud game;
the peripheral device comprises a gamepad configured to control a game object in the cloud game, the gamepad comprising at least one of a gamepad joystick, one or more gamepad keys, a six-axis sensor, and a touchpad; and
the obtaining the first service data information comprises:
generating, in response to a trigger operation on the peripheral device, the object operation data information based on the trigger operation; and
including the object operation data information in the first service data information,
wherein the object operation data information comprises at least one of:
one or more of axial parameter field of the gamepad, the one or more axial parameter field including one or more operation values that indicates one or more operations of the gamepad joystick on N direction axes, N being a positive integer greater than or equal to 3,
a key parameter field of the gamepad, the key parameter field including one or more operation key values of the one or more gamepad keys,
a sensor parameter field of the gamepad, the sensor parameter field including one or more sensing values of the six-axis sensor on K coordinate axes, K being a positive integer greater than or equal to 6, and the K coordinate axes comprising at least an acceleration coordinate axis and an angular velocity coordinate axis, and
a direction parameter field of the gamepad, the direction parameter field including one or more operation key values that indicates one or more operations towards M directions on the touchpad, and M being a positive integer greater than or equal to 4.

4. The method according to claim 1, wherein:
the obtaining the first service data information comprises:
querying a device attribute of the peripheral device when a device attribute query instruction from the cloud application client is received by using a first output interface of the peripheral device configured according to the first communication protocol;
generating the device attribute data information according to the queried device attribute; and
including the device attribute data information in the first service data information,
wherein the device attribute data information comprises at least one of:
a manufacturer parameter field of the peripheral device, the manufacturer parameter field indicating a manufacturer serial number of the peripheral device,
a device model parameter field of the peripheral device, the device model parameter field indicating a device model of the peripheral device,
a firmware parameter field of the peripheral device, the firmware parameter field indicating a firmware building time of the peripheral device,
a sensor parameter field of the peripheral device, the sensor parameter field indicating a measurement range and/or a sampling frequency of a six-axis sensor of the peripheral device, and
a service feature parameter field of the peripheral device, the service feature parameter field indicating a service feature supported by the peripheral device.

5. The method according to claim 1, wherein:
the obtaining the first service data information comprises:
generating, when a device battery strength of the peripheral device decreases to a battery strength threshold, the device battery strength data information based on the device battery strength, and
including the device battery strength data information in the first service data information;
wherein the device battery strength data information comprises at least a device battery strength parameter field that indicates the device battery strength of the peripheral device.

6. The method according to claim 1, wherein:
the obtaining the first service data information comprises:
querying a device battery strength of the peripheral device when a battery strength query instruction from the cloud application client is received by using a first output interface of the peripheral device configured according to the first communication protocol;
generating the device battery strength data information based on the queried device battery strength; and
including the device battery strength data information in the first service data information;
wherein the device battery strength data information comprises at least a device battery strength parameter field that indicates the device battery strength of the peripheral device.

7. The method according to claim 1, wherein:
the input service feature comprises one or more of:
a first service feature of obtaining input operation information to be included in the object operation data information,
a second service feature of obtaining a device attribute to be included in the device attribute data information, and
a third service feature of obtaining a device battery strength to be included in the device battery strength data information, and
the method further comprises:
receiving, by using a first output interface of the peripheral device configured
according to the first communication protocol, a device scanning instruction from the cloud application client;
obtaining, based on the device scanning instruction, first interface information that is supported by the peripheral device, the first interface information comprising at least one of: first object operation data interface information for obtaining the object operation data information, first attribute obtaining interface information for obtaining the device attribute data information, and first battery strength obtaining interface information for obtaining the device battery strength data information;
returning the first interface information to the cloud application client by using the first input interface according to the first communication protocol;
querying, when a device feature query instruction from the cloud application client for the first interface information is received through the first output interface, based on the device feature query instruction, a service feature supported by the peripheral device; and
returning the service feature to the cloud application client through the first input interface according to the first communication protocol, the service feature comprising the input service feature.

8. A method of data processing, comprising:
receiving, at a peripheral device and by using a first output interface of the peripheral device configured to support a first communication protocol, a first feedback instruction from a cloud application client running on a terminal device;
identifying, based on the first communication protocol, feedback data structure information according to the first feedback instruction, the feedback data structure information representing a feedback service feature of the peripheral device;
determining to use the feedback data structure information in first service data information associated with the peripheral device; and
performing a feedback operation based on the feedback data structure information in the first service data information, the feedback data structure information comprising at least one of device heartbeat feedback information and device vibration feedback information of the peripheral device.

9. The method according to claim 8, further comprising:
receiving, by the peripheral device, a mode switching instruction from the cloud application client based on the first communication protocol when the cloud application client starts a cloud application; and
switching the peripheral device from a second service mode to a first service mode based on the mode switching instruction, the peripheral device in the first service mode being configured to perform data transmission with the cloud application client based on the first communication protocol, and the peripheral device in the second service mode being configured to use a different communication protocol from the first communication protocol for the data transmission with the cloud application client.

10. The method according to claim 8, wherein:
the first feedback instruction that requests the device heartbeat feedback information is generated by the cloud application client and based on an operating system type of the terminal device when a heartbeat feedback condition is triggered;
a data structure of the device heartbeat feedback information comprises at least a heartbeat signal parameter field to include a heartbeat signal according to the operating system type of the terminal device; and
the performing the feedback operation comprises:
obtaining, when the feedback data structure information comprises the device heartbeat feedback information, client heartbeat feedback information to be the device heartbeat feedback information, the client heartbeat feedback information comprising at least the heartbeat signal parameter field; and
uploading the client heartbeat feedback information as at least a portion of the first service data information to the cloud application client by using a first input interface configured according to the first communication protocol.

11. The method according to claim 8, wherein the method further comprises:
switching, the peripheral device from a first service mode according to the first communication protocol for data transmission with the cloud application client to a second service mode according to a different communication protocol from the first communication protocol for the data transmission with the cloud application client, when a time in the first service mode reaches a target time threshold and the first feedback instruction that requests the device heartbeat feedback information is not received by the first output interface.

12. The method according to claim 8, wherein:
the peripheral device comprises at least one vibration motor;
the device vibration feedback information comprises at least:
one or more of a motor quantity parameter field configured to include a quantity of vibration motors that perform a vibration operation,
a vibration amplitude parameter field configured to include a vibration amplitude of a vibration motor during a vibration operation,
a vibration time parameter field configured to include a vibration time of a vibration operation,
a delay vibration time parameter field configured to include a delay vibration time of a vibration operation, and
a vibration cycle parameter field configured to include a quantity of vibration cycles of a vibration operation;
the performing the feedback operation comprises:
when the feedback data structure information comprises the device vibration feedback information, instructing, based on the device vibration feedback information, the at least one vibration motor to perform a vibration operation.

13. The method according to claim 8, wherein:
the peripheral device stores at least one piece of vibration effect control information indicating a vibration effect;
the vibration effect control information comprises at least one of:
a quantity of vibration motors to perform a vibration operation,
a vibration amplitude of a vibration motor during a vibration operation,
a vibration time for performing a vibration operation,
a delay vibration time for performing a vibration operation, and
a quantity of vibration cycles for performing a vibration operation;
each piece of vibration effect control information is associated with a corresponding vibration effect identifier,
the device vibration feedback information comprises at least an effect identifier field that includes a vibration effect identifier corresponding to a to-be-performed vibration operation; and
the performing the feedback operation comprises:
when the feedback data structure information comprises the device vibration feedback information, querying vibration effect control information associated with a vibration effect identifier according to the feedback data structure information, and
performing a vibration operation based on the queried vibration effect control information.

14. The method according to claim 8, wherein:
the feedback service feature comprises one or more of:
a first service feature configured to feed back a device heartbeat that corresponds to the device heartbeat feedback information, and
a second service feature configured to control a device vibration that corresponds to the device vibration feedback information, and
the method further comprises:
receiving a device scanning instruction from the cloud application client the first output interface;
obtaining, based on the device scanning instruction, first interface information supported by the peripheral device, the first interface information comprising at least one of: heartbeat feedback interface information corresponding to the device heartbeat feedback information, and vibration feedback interface information corresponding to the device vibration feedback information;
returning the first interface information to the cloud application client by using a first input interface according to the first communication protocol;
querying, when a device feature query instruction from the cloud application client for the first interface information is received through the first output interface, based on the device feature query instruction, a service feature supported by the peripheral device; and
returning the service feature to the cloud application client through the first input interface according to the first communication protocol, the service feature comprising the feedback service feature.

15. A method of data processing, the method comprising:
receiving, by a terminal device running a cloud application client and supporting a first communication protocol, first service data information associated with a peripheral device, the first service data information comprising input data structure information representing an input service feature of the peripheral device, and the input data structure information comprising at least one of object operation data information, device attribute data information, and device battery strength data information;
transmitting the first service data information to a virtual cloud client for the cloud application client, the virtual cloud client running in a cloud server, and the first service data information causing the cloud server to parse the first service data information to obtain input data information according to the input data structure information, obtain media data information in a response to the input data information and to return the media data information to the cloud application client;
receiving the media data information in the response to the input data information; and
outputting the media data information by using the cloud application client.

16. The method according to claim 15, further comprising:
providing a mode switching instruction from the terminal device to the peripheral device based on the first communication protocol when the cloud application client starts a cloud application, the mode switching instruction causing the peripheral device to switch from a second service mode to a first service mode, the peripheral device in the first service mode performing data transmission with the cloud application client based on the first communication protocol, the peripheral device in the second service mode using a different communication protocol from the first communication protocol for the data transmission with the cloud application client.

17. The method according to claim 15, wherein:
the cloud application client has started one or more cloud applications including a cloud game,
the peripheral device comprises a gamepad configured to control a game object in the cloud game, the gamepad comprising at least one of a gamepad joystick, one or more gamepad keys, a six-axis sensor, and a touchpad,
the object operation data information comprises at least one of:
one or more of an axial parameter field of the gamepad, the one or more of the axial parameter field including one or more operation values that indicates one or more operations of the gamepad joystick on N direction axes, N is a positive integer greater than or equal to 3,
a key parameter field of the gamepad, the key parameter field including one or more operation key values of the one or more gamepad keys,
a sensor parameter field of the gamepad, the sensor parameter field including one or more sensing values of the six-axis sensor on K coordinate axes, K being a positive integer greater than or equal to 6, and the K coordinate axes comprising at least an acceleration coordinate axis and an angular velocity coordinate axis, and
a direction parameter field of the gamepad, the direction parameter field including one or more operation key values, the one or more operation key values indicating one or more sliding operations towards M directions on the touchpad, and M being a positive integer greater than or equal to 4, and
the object operation data information is generated by the peripheral device, in response to a trigger operation performed by a service object on the peripheral device.

18. The method according to claim 15, further comprising:
transmitting a device attribute query instruction to the peripheral device based on a first output interface configured to support the first communication protocol, the device attribute query instruction causing the peripheral device to query a device attribute of the peripheral device and generate the device attribute data information according to the queried device attribute;
wherein the device attribute data information comprises at least one of:
a manufacturer parameter field of the peripheral device, the manufacturer parameter field indicating a manufacturer serial number of the peripheral device;
a device model parameter field of the peripheral device, the device model parameter field indicating a device model of the peripheral device;
a firmware parameter field of the peripheral device, the firmware parameter field indicating a firmware building time of the peripheral device, and
a sensor parameter field of the peripheral device, the sensor parameter field indicating a measurement range and/or a sampling frequency of a six-axis sensor of the peripheral device.

19. The method according to claim 15, wherein the device battery strength data information comprises at least a device battery strength parameter field that indicates a device battery strength of the peripheral device, and the device battery strength data information is generated by the peripheral device, when the device battery strength of the peripheral device is detected to be lower than a battery strength threshold.

20. The method according to claim 15, further comprising:
transmitting a battery strength query instruction to the peripheral device based on a first output interface configured to support the first communication protocol, the battery strength query instruction causing the peripheral device to query a device battery strength of the peripheral device and to generate the device battery strength data information based on the queried device battery strength; wherein the device battery strength data information comprises at least a device battery strength parameter field that indicates the device battery strength of the peripheral device.
